(19) United States
(12) Patent Application Publication
(10) Pub. No.: US 2012/0071553 A1
(43) Pub. Date: Mar. 22, 2012

(54) CHLORINE-FREE WATER TREATMENT

(75) Inventors: Michael P. Doyle, Peachtree City, GA (US); Tong Zhao, Peachtree City, GA (US)

(73) Assignee: University of Georgia Research Foundation, Inc., Athens, GA (US)

(21) Appl. No.: 13/234,286

(22) Filed: Sep. 16, 2011

Related U.S. Application Data
(60) Provisional application No. 61/384,528, filed on Sep. 20, 2010.

(51) Int. Cl. A01N 41/04; A01P 1/00; A23L 2/44

(52) U.S. Cl. 514/517; 426/330; 426/330.3; 426/330.5

(57) ABSTRACT

A combination of the surfactant SDS with levulinic acid produces a synergistic effect in relation to the antimicrobial effectiveness of the individual compounds, allowing the formulation of compositions wherein the active agents are present at concentrations effective to reduce bacterial and fungal counts in liquids, including, but not limited to, water and other beverages, without altering the organoleptic properties of the treated food substance. The active agents are FDA-approved as food additives, and the treated beverages can be any aqueous-based beverage consumable by humans or animals. The levulinic acid-SDS combination is also suitable for reducing or eliminating the microbial population on the surfaces of water and beverage containers, and the machinery and facilities for the bottling of liquids.

### CROSS-REFERENCE TO RELATED APPLICATIONS

This application claims priority to U.S. Provisional Patent Application Ser. No. 61/384,528, entitled “Chlorine-Free Water Treatment” filed on Sep. 20, 2010, the entirety of which is hereby incorporated by reference.

### TECHNICAL FIELD

The present disclosure is generally related to compositions and methods of use thereof for the treatment of liquids for reducing or eliminating a microbial population therein.

### BACKGROUND

Escherichia coli O157:H7 and Salmonella are major causes of severe food borne disease in the United States and continue to be of public health significance. Salmonella is one of the most frequent causes of food borne illnesses worldwide. In the United States, it causes an estimated 1.4 million cases of illness, approximately 20,000 hospitalizations, and more than 500 deaths annually (Mead, et al., 1999). FoodNet surveillance data of food borne illnesses revealed that the overall incidence of salmonellosis has decreased by only 8% from 1996-1998 to 2004 and the incidence of Salmonella enteritidis infections has remained at approximately the same level.

Other pathogens such as, for instance, Klebesiela, V. cholera, Proteus hauseri, Shigella, Yersinia pestis and B. anthracis, and protozoa, together with the more prominent E. coli and Salmonella, comprise a wide-spectrum of food- and water-borne pathogens that threaten the safety of the food supply and are now considered a matter of homeland security relevance. These food- and waterborne microorganisms are also associated with the spoilage of many beverages such as fruit juices, and other protein and/or sugar-containing beverages. Therefore, the development of a unique, pluripotent, widely applicable, and easy to manufacture countermeasure is desirable.

There is growing interest in the development of novel antimicrobial treatments such as combinations of natural antimicrobials, including generally recognized as safe (GRAS) chemicals to improve the microbiological safety of consumable food and beverage products. Phamaceutically acceptable chemical compositions have been formulated and have been demonstrated as effective in killing large cell numbers of Salmonella on chicken skin and in chicken processing water and both Salmonella and E. coli O157:H7 on fresh produce without producing any detectable impact on the organoleptic properties of the treated food. Such compositions have also been shown to be effective against a large spectrum of food-borne pathogens, leading to the reduction of pathogen populations by factors often greater than 7 log. The time needed for reaching such level of pathogen elimination range from a few seconds to about 2 minutes. Compositions of the disclosure have also been shown to be highly efficient in the treatment of pathogen biofilms formed on solid surfaces of type normally encountered on food manufacturing and processing facilities.

Spoilage of fruit juices by Alicyclobacillus species, especially by A. acidoterrestris, has become well-recognized since 1982 and is now a beverage industry-wide problem. Beverage spoilage by Alicyclobacillus results in a flat-sour type spoilage, with off-flavor and cloudiness. The production of guaicol and halogenated phenols is responsible for the primary off flavor, characterized as smoky and medicinal. Spores of Alicyclobacillus species can survive heat pasteurization processes applied to fruits, vegetables, fruit/vegetable-based beverages, fruit concentrates and purees, sugar, sugar syrups, tea, isotonic drinks (sports drinks), and other acidic beverage-type products. The heat resistance D₉₅° C. values in juices of Alicyclobacillus spores ranges from 0.06 to 5.3 min, with z-values of 7.2 to 12.8° C.

### SUMMARY

It has been discovered that a combination of the surfactant SDS with levulinic acid produces a synergistic effect in relation to the antimicrobial effectiveness of the individual compounds. Accordingly, this surprising synergy allows the formulation of compositions wherein the active agents are present at concentrations effective to reduce bacterial and fungal counts in liquids, including, but not limited to, water and other beverages, especially those having a pH value less than about 7.0, by a factor between 10³ and 10⁷ without altering the organoleptic properties of the treated food substance. The active agents are FDA-approved as food additives, and the treated beverages can be any aqueous-based beverage consumable by humans or animals.

One aspect of the present disclosure, therefore, encompasses the use of a composition comprising a pharmaceutically acceptable acid and a pharmaceutically acceptable surfactant, wherein the maximum concentration of total acid present in the composition is about 0.3 to about 3% by weight per volume in water (3-30 grams/L) and the maximum concentration of total surfactant is about 0.5% to about 1% by weight per volume in water (5-10 grams/L). The pharmaceutically acceptable levulinic acid is an acid that has been classified by the US Department of Agriculture as being Generally Regarded As Safe (GRAS).

One aspect of the present disclosure, therefore, encompasses embodiments of method of reducing a microbial population of a liquid, the method comprising contacting the liquid with between about 0.5% to about 5% by weight per volume of levulinic acid and between about 0.05% to about 2% by weight per volume of sodium dodecyl sulfate (SDS), wherein the levulinic acid and the SDS are effective in reducing the microbial load of the liquid.

In embodiments of this aspect of the disclosure, the liquid can be suitable for consumption by an animal or human.

In embodiments of this aspect of the disclosure, the liquid can have a pH value between about 0 and about 7.

In embodiments of this aspect of the disclosure, the liquid can be water or a beverage.

In some embodiments of this aspect of the disclosure, the beverage is a carbonated beverage.

In some embodiments of this aspect of the disclosure, the beverage can be a fruit or vegetable juice.

In some embodiments of this aspect of the disclosure, the beverage is an infusion.

In some embodiments of this aspect of the disclosure, the beverage is selected from coffee or tea.

In embodiments of this aspect of the disclosure, the levulinic acid and the SDS remain in the liquid after packaging of said liquid.

Another aspect of the disclosure encompasses embodiments of a method for decontaminating a solid surface of a beverage manufacturing facility, said method comprising the steps of contacting the solid surface with an aqueous composition comprising between about 0.5% to about 5% by weight per volume of levulinic acid and between about 0.05% to about 2% by weight per volume of sodium dodecyl sulfate (SDS).

In some embodiments of this aspect of the disclosure, the solid surface is of a beverage container.

In embodiments of this aspect of the disclosure, the beverage container is selected from the group consisting of: a bottle, a can, a carton, and a bag.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIGS. 1A-1E illustrate bar graphs demonstrating the efficacy of levulinic acid and SDS, alone or in combination, to kill spores of Bacillus anthracis Sterne. Spores were exposed to one of six different solutions: A: 3% levulinic acid plus 2% SDS; B: 2% levulinic acid plus 1% SDS; C, 0.5% levulinic acid plus 0.05% SDS; D: 3% levulinic acid; E: 2% SDS; and F: water (serving as the control) for various lengths of time (0 min., FIG. 1A; 10 min., FIG. 1B, 45 min., FIG. 1C; 90 min., FIG. 1D; 180 min., FIG. 1E), before testing the spores for viability relative to the control sample. Average plate counts are based on counting three plates; error bars indicate +/− one standard deviation.

FIGS. 2A-2E illustrate bar graphs demonstrating the efficacy of levulinic acid and SDS, alone or in combination, to kill spores of Bacillus anthracis Sterne. Spores were exposed to one of six different solutions: A: 3% levulinic acid plus 2% SDS; B: 2% levulinic acid plus 1% SDS; C, 0.5% levulinic acid plus 0.05% SDS; D: 3% levulinic acid; E: 2% SDS; and F: water (serving as the control) for time intervals of (0 min., FIG. 2A; 1 hour, FIG. 2B; 2 hours, FIG. 2C; 3 hours, FIG. 2D; or 4 hours, FIG. 2E), before testing the spores for viability relative to the control sample. In order to differentiate whether CFU originated from vegetative cells or from spores, at each time point samples were split in two equivalent aliquots. One aliquot was subjected to heat treatment (65° C., 30 min) to kill vegetative cells before enumeration of residual heat-resistant spores. The other aliquot was plated at room temperature (RT). Average plate counts are based on counting three plates; error bars indicate +/− one standard deviation.

FIGS. 3A-3E represent bar graphs demonstrating the efficacy of levulinic acid and SDS, alone or in combination, to kill spores of Bacillus anthracis Sterne. Spores were exposed to one of six different solutions: A: 3% levulinic acid plus 2% SDS; B: 2% levulinic acid plus 1% SDS; C, 0.5% levulinic acid plus 0.05% SDS; D: 3% levulinic acid; E: 2% SDS; and F: water (serving as the control) for time intervals of (0 min., FIG. 3A; 1 hour, FIG. 3B; 2 hours, FIG. 3C; or 3 hours, FIG. 3D; or 4 hours, FIG. 3E), before testing the spores for viability relative to the control sample. In order to differentiate whether CFU originated from vegetative cells or from spores, at each time point samples were split in two equivalent aliquots. One aliquot was subjected to heat treatment (65° C., 30 min) to kill vegetative cells before enumeration of residual heat-resistant spores. The other aliquot was plated at room temperature (RT). Average plate counts are based on counting three plates; error bars indicate +/− one standard deviation.

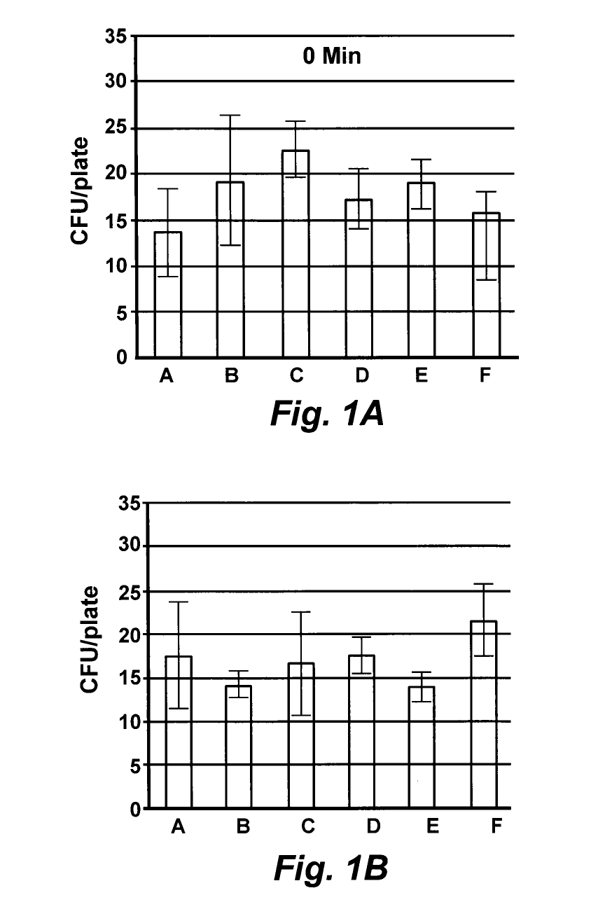

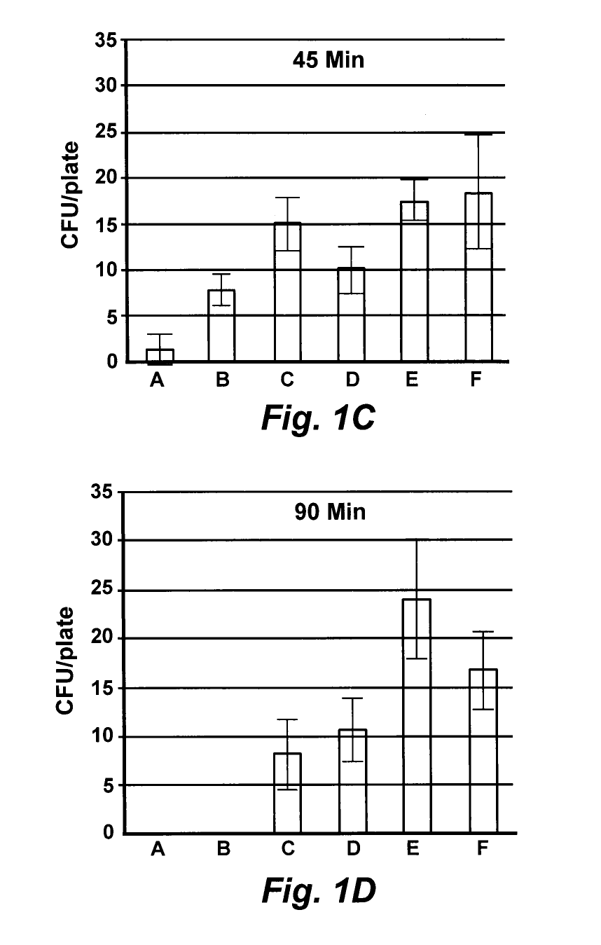

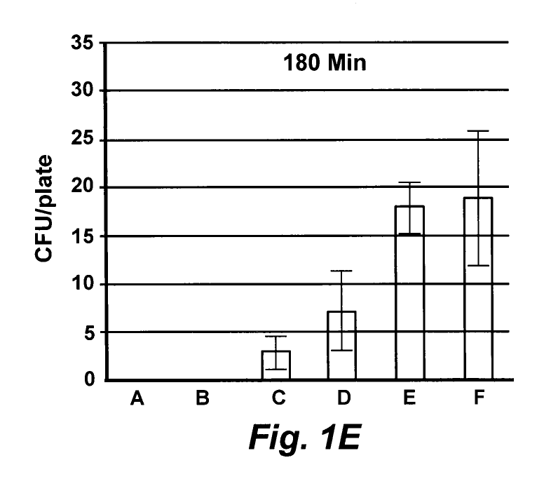

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of medicine, organic chemistry, biochemistry, molecular biology, pharmacology, and the like, which are within the skill of the art. Such techniques are explained fully in the literature.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, the following terms have the meanings ascribed to them unless specified otherwise. In this disclosure, “comprises,” “comprising,” “containing” and “having” and the like can have the meaning ascribed to them in U.S. Patent law and can mean “includes,” “including,” and the like; “consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. Patent law and the term is open-ended, allowing for the presence of more than that which is recited so long as basic or novel characteristics of that which is recited is not changed by the presence of more than that which is recited, but excludes prior art embodiments.

Prior to describing the various embodiments, the following definitions are provided and should be used unless otherwise indicated.

### DEFINITIONS

In describing and claiming the disclosure, the following terminology will be used in accordance with the definitions set forth below.

The term “beverage” as used herein refers to any liquid that can be consumed by a human or animal, including, but not limited to, water, tea, coffee, milk-based liquid products, carbonated sodas, non-carbonated beverages such as salt/nutrient replenishment drinks, fruit and vegetable-based drinks including juices, extracts, infusions, purees and the like, beers, wines, and the like. It is further intended that the compositions and methods of the present disclosure may be used to reduce the colonization or contamination of equipment intended for the preparation, handling and packaging of the liquid, and of packages such as bottles, cans, cartons, and the like that may be used for the storage, transport, or retail of the liquid.

As used herein the term “microorganism” or “microbe” is intended to include living cellular organisms, both unicellular and multicellular that are less than 5 mm in length, and include but are not limited to bacteria, fungi, archaea, protists; green algae, plankton, planarian, amoebas and yeasts (non-filamentous fungi), molds (filamentous fungi), or spores formed by any of these.

As used herein an “antimicrobial” is a compound that exhibits microbicidal or microbiostatic properties that enables the compound to kill, destroy, inactivate, or neutralize a microorganism; or to prevent or reduce the growth, ability to survive, or propagation of a microorganism.

As used herein the term “acid” refers to any chemical compound that, when dissolved in water, gives a solution with a hydrogen ion activity greater than in pure water, i.e. a pH less than 7.0. An “organic acid” is a carbon containing compound (except for carbonic acid) with acidic properties.

A monoprotic acid is an acid that is able to donate one proton per molecule during ionization.

As used herein, the term “pharmaceutically acceptable” is intended to encompass any compound that can be safely administered to warm blooded vertebrates including humans. Pharmaceutically acceptable acids and surfactants include acids and surfactants that are classified by the United States Food and Drug Administration (FDA) as being Generally Regarded As Safe (GRAS), and encompass any of the agents approved by a regulatory agency of the US Federal government or listed in the US Pharmacopeia for use in animals, including humans.

The term “pharmaceutically acceptable salt” as used herein refers to salts of compounds that retain the biological activity of the parent compound, and which are not biologically or otherwise undesirable. Many of the compounds disclosed herein are capable of forming acid and/or base salts by virtue of the presence of amino and/or carboxyl groups or groups similar thereto.

As used herein an “effective” amount or a “therapeutically effective amount” of an antimicrobial composition refers to a concentration of active agent that provides the desired effect, i.e., log order reduction in surface microbial counts in a liquid without reducing organoleptic properties of the food substance.

As used herein “organoleptic properties” relating to properties that can be detected by human or animal senses (taste, color, odor, feel) unaided by mechanical and analytical devices.

### DESCRIPTION

The present disclosure encompasses embodiments of methods to decontaminate or preserve liquids that are intended for animal or human consumption. The methods of the disclosure comprise adding directly to the liquid (which may have zero organic load such as water or be rich in organic compounds, such as, for example, beer, tea, coffee, fruit and vegetable juices or purees, and the like. The antimicrobial compositions for use in the methods of the disclosure comprise levulinic acid and a surfactant, wherein the concentration of the levulinic acid is about 0.5% to less than 2.5% (w/v) and the concentration of the surfactant is about 0.05% to 1% (w/v). This combination, including for example levulinic acid and SDS, has been found to be particularly efficacious as an antimicrobial composition that simultaneously preserves the organoleptic properties of a treated food substance. This specific combination has been shown to be several orders of magnitude superior and/or faster in its ability o kill pathogens, than other acid/surfactant combinations. The antimicrobial compositions disclosed herein are formulated at an acid pH, including for example a pH ranging from 2.5 to 3.5, and more typically a pH of 3.0 to 3.2, or may be added to a beverage that has a pH value of less than 7.0. The antimicrobial activity of the present compositions is accomplished without producing any detectable impact (by unaided human senses) on those properties of the treated product that are desired by the consumer. Even less desirable would be any changes that made the beverage either less palatable or adversely affect the storability of the treated product.

An antimicrobial composition is provided herein comprising a pharmaceutically acceptable acid and a pharmaceutically acceptable surfactant. Surprisingly, the compositions disclosed herein are capable of reducing a microbial population of a liquid or a surface in contact with or likely to be in contact with, a microorganism, by a factor greater than 10², including by a factor of 10³ to a factor of 10⁸, using a combination of an acid and surfactant at concentrations that are ineffective when used separatedly. The individual active ingredients of the present compositions (i.e., the pharrmaceutically acceptable acid and surfactant) are significantly less effective or ineffective in reducing microbial cell count by a factor greater than 10², even when the active agents are used separately at 2× or 5× the effective concentration asused in the combination. The concentration of the pharmaceutically acceptable acid in the antimicrobial composition is within the range of about 0.03% to about 3%, or about 0.05% to about 2%, or about 0.05% to about 1%, or about 0.1% to about 3%, or about 0.3% to about 3%, or about 0.3% to about 2%, or about 0.5% to about 3%, or about 0.5% to about 2%, or about 0.5% to about 1%, weight per volume in water. In some embodiments of the disclosure the concentration of the pharmaceutically acceptable surfactant in the antimicrobial composition is within the range of about 0.005% to about 1%, or about 0.01% to about 1%, or about 0.05% to about 1%, or about 0.1% to about 1%, or about 0.05% to about 2%, or about 0.5% to about 2% by weight per volume in water.

Previous studies revealed that combinations of different organic acids can be used as anti-bacterial agents based on their killing effects on E. coli O157:H7 and Campylobacter (Zhao, et al. 2006). Levulinic acid is an organic acid that can be produced cost effectively and in high yield from renewable feedstocks (Bozell, et al. 2000, Fang & Hanna, 2002). Its safety for humans has been widely tested and FDA has given it GRAS status for direct addition to food as a flavoring agent or adjunct (21 CFR, 172.515). As disclosed herein, the antimicrobial effect of 1% by weight levulinic acid alone will not suffice to kill more than 1 log CFU Salmonella/ml within 30 minutes, and its bactericidal effect was increased only to 3.4 log CFU/ml within 30 minutes when the levulinic acid concentration was increased to 3% by weight (see Tables 1-3).

Sodium dodecyl sulfate (SDS) also has GRAS status (21 CFR, 172.210) at 0.5% wt of gelatin, as a whipping agent in gelatin used in marshmallows and at 0.0125% in liquid and frozen egg whites. It has been widely studied and is used as a surfactant in household products such as toothpastes, shampoos, shaving foams, and bubble baths. The SDS molecule has a tail of 12 carbon atoms attached to a sulfate group, giving the molecule the amphiphilic properties required of a surfactant. As disclosed herein the use of SDS by itself has very little antimicrobial effect.

The substantial bactericidal effect of a combination of levulinic acid and SDS on E. coli O157:H7 and Salmonella was validated using water containing different levels of chicken feces or feathers (see Example 1, Tables 4-7). The bactericidal activity of this combination of chemicals remained effective even in an extreme organic-rich environmental containing fecal matter or feathers.

The embodiments of the methods of the present disclosure provide for contacting a beverage having a pH value of less than 7.0 with an antimicrobial composition comprising pharmaceutically acceptable surfactant and a pharmaceutically acceptable organic acid, wherein the concentration of the organic acid is 0.5% by weight/volume or less and the concentration of the surfactant is 0.05% by weight/volume or less. It is desirable, however, that since the antimicrobial compositions of the disclosure are to be effectively used in beverages, including, but not limited to, water that the organic acid be palatable and not leave an unacceptable taste or odor that may not be acceptable to a consumer of the liquid.

The composition comprises a maximum concentration of 0.3 to 3% by weight of one or more organic acids selected from the group consisting of lactic acid, acetic acid, and levulinic acid and a maximum concentration of 0.05 to 2% by weight SDS. In one embodiment the composition comprises 0.3 to 3% by weight levulinic acid and 0.05 to 1% by weight SDS.

The antimicrobial compositions disclosed herein can be used to reduce the population of an undesirable microbe in a liquid such as water or a beverage, including a beverage with significant organic load. A reduction of a population of a microbe can be achieved when the populations of the microbe is reduced by at least 2 log.

An antimicrobial composition comprising levulinic acid and a surfactant is provided wherein the composition is effective in reducing resident microbial populations on food substances, including on liquid consumables. In one embodiment, a food contaminated with 10⁸-10⁹ CFU/ml E. coli O157:H7 can be treated with the antimicrobial compositions disclosed herein to reduce the presence of viable bacteria by a factor greater than 10³ (including reductions of 10⁴, 10⁵, 10⁶ and 10⁷ or even higher) after exposure to said composition for five minutes, under conditions otherwise favorable to proliferation of said E. coli O157:H7. The concentration of said levulinic acid and surfactant are at concentrations that are ineffective in reducing said resident microbial population when used separatedly. The concentration of each of the levulinic acid and surfactant components is at a concentration 0.5×, 0.25×, 0.1×, or less than 0.1×, of the concentration required to produce a significant reduction (e.g., greater than one log reduction within 5 minutes) in an E. coli O157:H7 microbial population when the respective component (i.e., levulinic acid or surfactant) is used separately. In one embodiment the concentration of the levulinic acid in the compositions of the present disclosure is no more than 3%, 2.5%, 2.0%, 1.5%, 1.0%, 0.5% or 0.25% (w/v). In one embodiment the concentration of the levulinic acid is less than 2.5% (w/v) or less than 2.0% (w/v) and in a further embodiment the concentration of the levulinic acids is about 0.5% (w/v) levulinic acid. These concentrations of levulinic acid in combination with a pharmaceutically acceptable surfactant at concentrations of less than 2% have been found to retain the organoleptic properties of foods, including produce. The concentration of the surfactant in one embodiment of the present compositions is no more than about 0.01% to about 1%, or about 0.01% to about 0.1% and more typically is about 0.05% (w/v).

A method for the rapid killing of microbial strains, including bacteria, yeasts, and molds, is provided. The method comprises contacting a beverage with a composition comprising a SDS and levulinic acid, wherein the concentration of the organic acid is 3.0%, 2.0%, 1.0% or 0.5% (w/v) or less and the concentration of the surfactant is less than 1%, 0.5%, 0.1% or 0.05% (w/v). In these embodiments the composition can comprise a maximum concentration of 0.3 to 3% by weight levulinic acid and a maximum concentration of 0.05 to 1% by weight SDS.

In another aspect of the disclosure, an object in a food processing environment, including, but not limited to, the equipment required for bottling a beverage, or the containers such as bottles, cartons, cans, sacs, sachets, and the like, can be treated with the antimicrobial compositions.

Processing equipment is commercially available for washing beverage containers, and applicants have found that the levulinic compositions of the present disclosure (eg. compositions having a concentration up to 3% levulinic acid) are not corrosive to such equipment. In particular, applicants have found that when using a large stainless steel seed washing unit, not only was the levulinic acid/SDS treatment as effective in killing E. coli O157:H7 as the current industrial standard of 20,000 ppm calcium hypochlorite, but it was not corrosive to the equipment and even removed rust on chains within the unit. Thus the levulinic acid composition served to clean the unit like a detergent without the undesirable corrosive effect on equipment that is associated with many sanitizers such as chlorine. Accordingly, one embodiment of the present disclosure is also directed to a method of decontaminating equipment and hard surfaces by contacting such equipment and hard surfaces with the levulinic compositions of the present disclosure.

The methods of the disclosure, therefore, comprise contacting the liquid or surface with a composition comprising levulinic acid and SDS, wherein the composition comprises a maximum concentration of 3% by weight levulinic acid and 2% by weight SDS. The reduction of pathogens, including Salmonella and E. coli O157:H7, spore-forming bacteria, yeasts and molds resulting from the use of the compositions disclosed herein is a log reduction (>5 log/ml or greater within one minute).

In one embodiment the beverage is contacted with the levulinic acid/surfactant containing solution for a predetermined length of time such as about 1, 2, 3, 4, 5 or 10 minutes. Such time intervals have been found to be effective in reducing viable cell counts by at least 3 orders of magnatude. More particularly, applicants have demonstrated that compositions comprising levulinic acid, at a concentration of 3% (w/v) or less, in combination with a surfactant (such as SDS) reduces viable microbe cells counts by a factor of 5 to logs within 1 to 5 minutes of contact under conditions otherwise suitable for microbe growth.

Formulations based on levulinic acid are cheap, easy to produce, do not produce bad odor, are environmentally acceptable, and have been approved for use in food by FDA.

The antimicrobial compositions of the present disclosure can be used to remove surface microbial contamination from a solid surface, including for example, a beverage processing equipment, bottling machinery, or the receiving containers such as bottles or cans. The method comprises contacting the surface with the antimicrobial composition, optionally in the form of a foamed composition. In one embodiment the biofilm is contacted with an aqueous composition comprising 0.5% to 3% by weight per volume in water of lebulinic acid and 0.05% to 2% by weight per volume in water of an ionic surfactant. In one embodiment the concenteration of the levulinic acid is less than 3%, 2.5%, 2.0%, 1.5%, 1.0%, 0.5% or 0.25% (w/v) of the aqueous composition and the concentration of the sodium dodecyl sulfate and/or sodium laureth sulfate is less than 2.0, 1.5, 1.0, 0.5, 0.1 or 0.05% (w/v) of the aqueous composition.

One aspect of the present disclosure, therefore, encompasses embodiments of method of reducing a microbial population of a liquid, the method comprising contacting the liquid with between about 0.5% to about 5% by weight per volume of levulinic acid and between about 0.05% to about 2% by weight per volume of sodium dodecyl sulfate (SDS), wherein the levulinic acid and the SDS are effective in reducing the microbial load of the liquid.

In embodiments of this aspect of the disclosure, the liquid can be suitable for consumption by an animal or human.

In embodiments of this aspect of the disclosure, the liquid can have a pH value between about 0 and about 7.

In embodiments of this aspect of the disclosure, the liquid can be water or a beverage.

In some embodiments of this aspect of the disclosure, the beverage is a carbonated beverage.

In some embodiments of this aspect of the disclosure, the beverage can be a fruit or vegetable juice.

In some embodiments of this aspect of the disclosure, the beverage is an infusion.

In some embodiments of this aspect of the disclosure, the beverage is selected from coffee or tea.

In embodiments of this aspect of the disclosure, the levulinic acid and the SDS remain in the liquid after packaging of said liquid.

Another aspect of the disclosure encompasses embodiments of a method for decontaminating a solid surface of a beverage manufacturing facility, said method comprising the steps of contacting the solid surface with an aqueous composition comprising between about 0.5% to about 5% by weight per volume of levulinic acid and between about 0.05% to about 2% by weight per volume of sodium dodecyl sulfate (SDS).

In some embodiments of this aspect of the disclosure, the solid surface is of a beverage container.

In embodiments of this aspect of the disclosure, the beverage container is selected from the group consisting of: a bottle, a can, a carton, and a bag.

The specific examples below are to be construed as merely illustrative, and not limiting of the remainder of the disclosure in any way whatsoever. Without further elaboration, it is believed that one skilled in the art can, based on the description herein, utilize the present disclosure to its fullest extent. All publications recited herein are hereby incorporated by reference in their entirety.

It should be emphasized that the embodiments of the present disclosure, particularly, any “preferred” embodiments, are merely possible examples of the implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure, and the present disclosure and protected by the following claims.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in 20° C., and pressure is at or near atmospheric. Standard temperature and pressure are defined as 20° C. and 1 atmosphere.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified.

### EXAMPLES

### Example 1

Microbiocidal Efficacy of the Organic Acid/SDS Compositions: Five isolates of E. coli O157:H7, including 932 (human isolate), E009 (beef isolate), E0018 (cattle isolate), E0122 (cattle isolate), E0139 (deer jerky isolate); and five isolates of Salmonella typhimurium DT104, including three cattle isolates and two meat isolates; and five isolates of Salmonella enteritidis, including 564-88 (food isolate), 193-88 (human isolate), E39 (egg isolate), 460-88 (egg isolate) and 457-88 (poultry isolate); and five isolates of L. monocytogenes, including LM101 (serotype 4b, salami isolate), LM 112 (serotype 4b, salami isolate), LM113 (serotype 4b, pepperoni isolate), LM9666 (serotype ½c, human isolate), and LM5779 (serotype ½ c, cheese isolate); and one isolate of Yersinia pestis (A1122) were used. Each Salmonella and E. coli O157:H7 strain was grown in tryptic soy broth (TSB) at 37° C. for 18 h then washed in 0.1 M phosphate buffered saline pH 7.2. Approximately equal cell numbers of each of the five strains were combined and used as a 5-strain mixture with cell numbers being adjusted according to the experimental design. Bacterial cell numbers were confirmed by serial dilutions (1:10) in 0.1% peptone and a volume of 0.1 ml from each dilution tube was plated on tryptic soy agar (TSA), XLD agar, and Sorbitol MacConkey agar (SMA), incubated at 37° C. for 24 h, and colonies were counted.
Chemicals and chemical treatment: Acetic acid, caprylic acid, lactic acid, levulinic acid and sodium dodecyl sulfate (SDS) were tested alone or as a combination at different concentrations and temperatures (8° C. or 21° C.) for their killing effect on S. enteritidis, S. typhimurium, and E. coli O157:H7 in water contaminated with chicken feces or feathers with and without feces and on chicken skin with and without chicken feces.
Chicken feathers, skin, poultry wings and feces: Feces from a poultry farm was collected from 5 different chickens and used as a mixture. Feathers were obtained from a slaughterhouse. Chicken and poultry wings were purchased from a slaughter plant or local retail store and skin was separated immediately before use. Only Salmonella-negative chicken feces, feather, skin, or poultry wing samples were used for the experiments. A volume of 10 ml of deionized water and 1.0 g feces, or feathers, or a piece of skin (5×5 cm²) was added to a Whirl-Pak bag. Each bag of feces, feather, or skin sample was pummeled in a stomacher blender at 150 rpm for 1 min. The bag of poultry wing was massaged by hands for 1 min. The fluid was serially (1:10) diluted in 0.1% peptone and 0.1 ml from each dilution tube was plated in duplicate on XLD plates to determine if these samples were contaminated with salmonellae. Only Salmonella-negative chicken feces, feather, or skin samples were selected for experiments.
Enumeration of S. enteritidis, S. typhimurium DT104 and E. coli O157:H7: At each sampling time, 1.0 ml of the treated bacterial suspension was mixed with 9.0 ml of neutralizing buffer or PBS (depending on the pH). The solution was serially (1:10) diluted in 0.1% peptone water and 0.1 ml of each dilution was surface-plated onto TSA and XLD, or TSA and XLD containing ampicillin (32 μg/ml), tetracycline (16 μg/ml) and streptomycin (64 μg/ml) (TSA+, XLD+), or TSA and Sorbitol MacConkey agar plates in duplicate. The plates were incubated at 37° C. for 48 h. Colonies typical of Salmonella or E. coli O157:H7 were randomly picked from plates with the highest dilution for confirmation of Salmonella or E. coli by biochemical tests and for confirmation of serotyping by latex agglutination assay. When Salmonella or E. coli O157:H7 were not detected by direct plating, a selective enrichment in universal preenrichment broth (UPB) was performed by incubating 25 ml of treatment suspension in a 500-ml flask containing 225 ml of UPB for 24 h at 37° C. Following pre-enrichment, 1 ml was transferred to 10 ml of selenite cystine broth and incubated for 24 h at 37° C. Following incubation, a 10-μl loopful from the broth tube was plated in duplicate onto XLD plates, and incubated for 24 h at 37° C. Colonies with typical Salmonella spp. morphology were selected and transferred one more time on XLD plates and incubated for 24 h at 37° C. All presumptive Salmonella isolates were tested by the Salmonella latex agglutination assay. Isolates positive for Salmonella by the latex agglutination assay were tested with the API 20E assay for biochemical characteristics for the identification of Salmonella. Studies with all chemical treatments were done in duplicate or triplicate, two replicates were plated per sample and results were reported as means.
Determination of Salmonella inactivation in water contaminated with chicken feathers or feces: The protocols used were the same as described previously (Zhao, et al. 2006), with minor modifications. Chicken feathers or feces were weighed and added into a glass beaker containing chemicals to be determined according to different ratios (w/v) in a glass beaker and mixed by a magnetic bar with agitation at 150 rpm. A 5-strain mixture of S. enteritidis was added. A volume of 1 ml sample was removed and serially diluted (1:10) in PBS. The aerobic bacterial and Salmonella counts were determined according to the procedures we described above.
Results: Determination of Salmonella inactivation in water with 0.1 to 2.0% by weight levulinic acid revealed about a 1-log CFU/ml reduction. Its killing effect was greater when the levulinic acid concentration was increased to 3.0% by weight, resulting in a 3.4-log Salmonella/ml reduction when in contact for 30 minutes (Table 1). Treatments of 0.5% by weight acetic acid and 0.5% by weight lactic acid for 30 minutes reduced Salmonella cell numbers by 0.7- and 2.0-log CFU/ml, respectively. A treatment of 0.05% by weight SDS for 30 minutes did not reduce Salmonella cell numbers (Table 1).

All the combinations of organic acids evaluated in combination with 0.03-0.05% by weight SDS were effective, at different degrees, in killing Salmonella, with the population of Salmonella quickly reduced from 10⁷ CFU/ml to undetectable (enrichment-negative) with a contact time of 5-10 seconds (see Table 1).

Neither levulinic acid at 0.5% by weight nor SDS at 0.05% by weight when applied individually provided a significant killing effect on either E. coli O157:H7 or S. typhimurium DT 104; however, the combination of levulinic acid and SDS at these concentrations reduced E. coli O157 and S. typhimurium cell numbers by 7 log CFU/ml within 1 min (see Tables 2 & 3).

The levulinic acid and SDS treatment to kill S. enteritidis was further tested in water containing chicken feathers or feces. Results revealed that feather contamination did not reduce the killing effect of that treatment, whereas the presence of chicken feces did. S. enteritidis was reduced from 7.6 log CFU/ml to 1.2 log CFU/ml in chicken feces contaminated water after 2 min exposure, but was not detected (7.6 log CFU/ml reduction) after 5 min (P<0.05; Table 4). Greater concentrations of levulinic acid and SDS were more effective in killing Salmonella, even in water heavily contaminated with chicken feces (1 part feces: 20 parts water; wt/v) (Table 4).

Aerobic bacteria counts in water contaminated with chicken feces at a ratio of 1:100 (w/v) were reduced by >4.0 log CFU/ml after treatment with 1% by weight levulinic acid and 0.1% by weight SDS for 2 min. The antimicrobial effect was increased to ca. 5.5 log CFU/ml reduction in water contaminated with chicken feces at a ratio of 1:20 (w/v) when the chemical concentrations were increased to 3% by weight levulinic acid plus 2.0% by weight SDS for 2 min (Table 5).

As disclosed herein a combination of two chemicals, which includes an organic acid (classified as generally recognized as safe by FDA, including lactic acid, acetic acid, levulinic acid, caprylic acid, et al.) and sodium dodecyl sulfate (SDS, the anionic surfactant compound) can be used to kill harmful bacterial present on food substances and/or food processing surfaces. In one embodiment the chemical combination comprises 45 mM levulinic acid and 1.73 mM SDS, which can rapidly (within 8 seconds) kill up to 7 log of pathogens, including Yersinia pestis, Salmonella enteritidis, S. typhimurium DT104, Listeria monocytogenes, and Escherichia coli O157:H7. This chemical combination is stable at room temperature and environmentally friendly. There is no apparent organoleptic difference between fresh produce treated with this chemical solution for up to 60 minutes and fresh produce treated with water or without treatment.

TABLE 1
Reduction of S. enteritidis in water treated with organic acids and
SDS at 21° C.

| | S. enteritidis counts | | | | | |
|---|---|---|---|---|---|---|
| | (log CFU/ml) at min: | | | | | |
| Chemical Treatment | 0 | 2 | 5 | 10 | 20 | 30 |
| S. enteritidis only (pH 6.7) (Control) | 7.2 | 7.0 | 7.1 | 7.2 | 7.0 | 7.2 |
| 0.1% levulinic acid (pH 2.5) | 7.1 | 7.1 | 6.9 | 7.0 | 6.9 | 6.9 |
| 0.5% levulinic acid (pH 2.6) | 7.1 | 6.8 | 6.9 | 6.9 | 6.6 | 6.7 |
| 1.0% levulinic acid (pH 2.9) | 6.9 | 6.7 | 6.8 | 6.9 | 6.9 | 6.7 |
| 1.5% levulinic acid (pH2.8) | 6.7 | 6.7 | 6.8 | 6.7 | 6.4 | 6.5 |
| 2.0% levulinic acid (pH 2.8) | 6.7 | 6.7 | 6.7 | 6.8 | 6.5 | 6.0 |
| 2.5% levulinic acid (pH 2.6) | 6.9 | 6.8 | 6.9 | 6.4 | 5.8 | 4.8 |
| 3.0% levulinic acid (pH 2.7) | 6.6 | 6.8 | 6.5 | 6.2 | 5.1 | 3.8 |
| 0.5% acetic acid (pH 3.1) | 7.1 | 7.0 | 6.8 | 6.7 | 6.6 | 6.5 |
| 0.5% lactic acid (pH 2.6) | 6.5 | 6.1 | 5.9 | 5.8 | 5.5 | 5.2 |
| 0.05% sodium dodecyl sulfate (pH 4.4) | 7.1 | 7.0 | 7.2 | 7.1 | 7.2 | 7.1 |
| 0.3% levulinic acid + 0.05% SDS (pH 3.1) | −^{a} | − | − | − | − | − |
| 0.4% levulinic acid + 0.05% SDS (pH 2.9) | − | − | − | − | − | − |
| 0.5% levulinic acid + 0.05% SDS (pH 3.0) | − | − | − | − | − | − |
| 0.5% levulinic acid + 0.03% SDS (pH 3.0) | − | − | − | − | − | − |
| 0.05% caprylic acid + 0.03% SDS (pH 3.4) | − | − | − | − | − | − |
| 0.05% caprylic acid + 0.05% SDS (pH 3.2) | − | − | − | − | − | − |
| 0.5% acetic acid + 0.05% SDS (pH 3.0) | − | − | − | − | − | − |
| 0.5% lactic acid + 0.05% SDS (pH 2.5) | − | − | − | − | − | − |

^{a}−, negative by enrichment culture.

TABLE 2
Reduction of E. coli O157:H7 in water treated with levulinic acid and
SDS at 21° C.

| | E. coli O157:H7 counts | | | | | | | |
|---|---|---|---|---|---|---|---|---|
| | (log CFU/ml) at min: | | | | | | | |
| Chemical Treatment | 0 | 1 | 2 | 5 | 10 | 20 | 30 | 60 |
| E. coli O157:H7 only (Control) | 7.1 | 7.2 | 7.0 | 7.2 | 7.1 | 7.1 | 7.2 | 7.2 |
| 0.5% levulinic acid-(pH 3.0) | 7.0 | 6.7 | 6.8 | 6.7 | 6.9 | 6.8 | 6.8 | 6.4 |
| 0.05% SDS-(pH 7.0) | 7.1 | 6.9 | 7.1 | 7.0 | 6.9 | 6.9 | 7.1 | 7.0 |
| 0.5% levulinic acid + 0.05% | −^{a} | − | − | − | − | − | − | − |
| SDS-(pH 3.0) | | | | | | | | |

^{a}−, negative by enrichment culture

TABLE 3
Reduction of S. typhimurium DT 104 in water treated with levulinic
acid + SDS at 21° C.

| | S. typhimurium DT 104 counts | | | | | | | |
|---|---|---|---|---|---|---|---|---|
| | (log CFU/ml) at min: | | | | | | | |
| Chemical Treatment | 0^{a} | 1 | 2 | 5 | 10 | 20 | 30 | 60 |
| S. typhimurium only (Control) | 6.9 | 7.0 | 7.0 | 7.0 | 7.0 | 6.9 | 7.0 | 7.0 |
| 0.5% levulinic acid (pH 3.0) | 6.8 | 6.7 | 6.6 | 6.5 | 6.7 | 6.6 | 6.4 | 5.9 |
| 0.05% SDS (pH 7.0) | 7.0 | 7.0 | 6.8 | 6.9 | 6.8 | 6.9 | 6.9 | 6.9 |
| 0.5% levulinic acid + 0.05% SDS | +^{a} | −^{b} | − | − | − | − | − | − |
| (pH 3.0) | | | | | | | | |

^{a}+, positive by enrichment (minimum detection level is 0.7 log CFU/ml)
^{b}−, negative by enrichment culture

TABLE 4
S. enteritidis counts for treatment of levulinic acid plus SDS in
water containing chicken feathers or feces at 21° C.

| | S. enteritidis counts | | | | | |
|---|---|---|---|---|---|---|
| | (log CFU/ml) at min: | | | | | |
| Treatment | 0 | 2 | 5 | 10 | 20 | 30 |
| In water containing chicken | | | | | | |
| feathers (1:100, w/v) | | | | | | |
| S. enteritidis (pH 6.7) only | 7.5 | 7.7 | 7.4 | 7.5 | 7.6 | 7.6 |
| 1.0% levulinic acid + 0.1% | <0.7^{a} | <0.7 | <0.7 | <0.7 | <0.7 | <0.7 |
| SDS (pH 3.2) | | | | | | |
| In water containing chicken | | | | | | |
| feces (1:100, w/v) | | | | | | |
| S. enteritidis only (pH 6.8) | 7.6 | 7.5 | 7.5 | 7.6 | 7.5 | 7.6 |
| 1.0% levulinic acid + 0.1% | 4.9 | 1.2 | <0.7 | <0.7 | <0.7 | <0.7 |
| SDS (pH 4.0) | | | | | | |
| In water containing chicken | | | | | | |
| feces (1:20, w/v) | | | | | | |
| S. enteritidis only (pH 6.7) | 7.7 | 7.8 | 7.7 | 7.7 | 7.7 | 7.6 |
| 3.0% levulinic acid + 2.0% | <0.7 | <0.7 | <0.7 | <0.7 | <0.7 | <0.7 |
| SDS (pH 4.0) | | | | | | |

^{a}Minimum detection level by direct plating method

TABLE 5
Aerobic bacteria counts for treatment of levulinic acid plus SDS in
water containing chicken feces at 21° C.

| | Aerobic bacteria counts | | | | | |
|---|---|---|---|---|---|---|
| | (log CFU/ml) at min: | | | | | |
| Treatment | 0 | 2 | 5 | 10 | 20 | 30 |
| In water containing chicken | | | | | | |
| feces (1:100, w/v) | | | | | | |
| Aerobic bacteria only | 7.4 | ND^{a} | ND | 7.4 | 7.4 | 7.4 |
| 1.0% levulinic acid + 0.1% | 5.0 | 3.0 | 2.9 | 2.9 | 2.0 | 2.0 |
| SDS (pH 4.0) | | | | | | |
| In water containing chicken | | | | | | |
| feces (1:20, w/v) | | | | | | |
| Aerobic bacteria only | 10.4 | 10.4 | 10.3 | 10.4 | 10.4 | 10.4 |
| 3.0% levulinic acid + 2.0% | 4.5 | 4.9 | 5.1 | 4.9 | 5.1 | 5.1 |
| SDS (pH 4.0) | | | | | | |

^{a}ND, Not determined.

TABLE 6
Effect of a combination with 0.5% levulinic acid and 0.05% SDS, pH 3.1 at 21° C. on
different bacterial species

| | Bacterial counts | | | | | | | |
|---|---|---|---|---|---|---|---|---|
| | (log CFU/ml) at min: | | | | | | | |
| Bacterial Name | 0^{a} | 1 | 2 | 5 | 10 | 20 | 30 | 60 |
| Klebsiella pneumonia in 0.1M PBS | ND^{b} | ND | ND | 6.5 | ND | ND | ND | 6.6 |
| (Control) | | | | | | | | |
| K. pneumonia in 0.5% levulinic acids + | —^{c} | — | — | — | — | — | — | — |
| 0.05% SDS (pH 3.1) | | | | | | | | |
| Hafinia alvei in 0.1M PBS (control) | ND | ND | ND | 6.9 | ND | ND | ND | 6.9 |
| H. alvei in 0.5% levulinic acids + | — | — | — | — | — | — | — | — |
| 0.05% SDS (pH 3.1) | | | | | | | | |
| Klebsiella oxytoca in 0.1M PBS | ND | ND | ND | 7.2 | ND | ND | ND | 7.1 |
| (Control) | | | | | | | | |
| K. oxytoca in 0.5% levulinic acids + | — | — | — | — | — | — | — | — |
| 0.05% SDS (pH 3.1) | | | | | | | | |
| Proteus hauseri in 0.1M PBS | ND | ND | ND | 7.3 | ND | ND | ND | 7.4 |
| (Control) | | | | | | | | |
| Pr. hauseri in 0.5% levulinic acids + | — | — | — | — | — | — | — | — |
| 0.05% SDS (pH 3.1) | | | | | | | | |
| Serratia marcesens in 0.1M PBS | ND | ND | ND | 7.3 | ND | ND | ND | 7.3 |
| (Control) | | | | | | | | |
| Ser. marcesens in 0.5% levulinic | — | — | — | — | — | — | — | — |
| acids + 0.05% SDS (pH 3.1) | | | | | | | | |
| Shigella flexneri in 0.1M PBS | ND | ND | ND | 7.1 | ND | ND | ND | 7.1 |
| (Control) | | | | | | | | |
| Shi. flexneri in 0.5% levulinic acids + | — | — | — | — | — | — | — | — |
| 0.05% SDS (pH 3.1) | | | | | | | | |
| Shi. sonnei in 0.1M PBS (Control) | ND | ND | ND | 7.3 | ND | ND | ND | 7.3 |
| Shi. sonnei in 0.5% levulinic acids + | — | — | — | — | — | — | — | — |
| 0.05% SDS (pH 3.1) | | | | | | | | |
| Staphylococcus aureus in 0.1M PBS | ND | ND | ND | 6.9 | ND | ND | ND | 6.9 |
| (Control) | | | | | | | | |
| Staph. aureus in 0.5% levulinic acids + | — | — | — | — | — | — | — | — |
| 0.05% SDS (pH 3.1) | | | | | | | | |
| Aerococcus viridans in 0.1M PBS | ND | ND | ND | 6.0 | ND | ND | ND | 6.0 |
| (control) | | | | | | | | |
| Aero. viridans in 0.5% levulinic acids + | — | — | — | — | — | — | — | — |
| 0.05% SDS (pH 3.1) | | | | | | | | |
| Yersinia pseudotubersulosis in 0.1M | ND | ND | ND | 7.0 | ND | ND | ND | 7.0 |
| PBS (control) | | | | | | | | |
| Y. pseudotubersulosis in 0.5% | — | — | — | — | — | — | — | — |
| levulinic acids + 0.05% SDS (pH 3.1) | | | | | | | | |
| E. coli O26:H11 in 0.1M PBS | ND | ND | ND | 7.2 | ND | ND | ND | 7.2 |
| (Control) | | | | | | | | |
| E. coli O26:H11 in 0.5% levulinic | — | — | — | — | — | — | — | — |
| acids + 0.05% SDS (pH 3.1) | | | | | | | | |
| E. coli O111:NM in 0.1M PBS | ND | ND | ND | 7.1 | ND | ND | ND | 7.1 |
| (Control) | | | | | | | | |
| E. coli O111:NM in 0.5% levulinic | — | — | — | — | — | — | — | — |
| acids + 0.05% SDS (pH 3.1) | | | | | | | | |
| Vibro chloerae in 0.1M PBS (control) | ND | 5.1 | 5.0 | ND | ND | ND | 4.2 | ND |
| V. chloerae in 0.5% levulinic acids + | — | — | — | — | — | — | — | — |
| 0.05% SDS (pH 3.1) | | | | | | | | |
| Campylobacter jejuni in 0.1M PBS | 8.2 | 8.3 | 8.1 | 8.0 | 8.4 | 8.1 | 8.2 | 8.4 |
| (control) | | | | | | | | |
| Camp. jejuni in 0.5% levulinic acids + | <0.7 | <0.7 | <0.7 | <0.7 | <0.7 | <0.7 | <0.7 | <0.7 |
| 0.05% SDS (pH 3.1) | | | | | | | | |

(ND = Not Determined; a dash “—” indicates “not detected”)
^{a}Initial inoculation level: Hafinia alvei: 1.9 × 10⁸ CFU/ml; Klebsiella oxytoca: 2.1 × 10⁹ CFU/ml; Proteus hauseri: 1.3 × 10⁹ CFU/ml; Serratia marcesens: 1.2 × 10⁹ CFU/ml; Shigella flexneri: 1.1 × 10⁹ CFU/ml; Shigella sonnei: 1.3 × 10⁹ CFU/ml; Staphylococcus aureus: 1.9 × 10⁸ CFU/ml; Aerococcus virians: 1.0 × 10⁸ CFU/ml; Yersinia pseudotuberculosis: 1.0 × 10⁹ CFU/ml; E. coli O26:H11: 1.2 × 10⁹ CFU/ml; E. coli O111:NM: 1.1 × 10⁹; Vibro cholerae: 1.2 × 10⁶ CFU/ml; Campylobacter jejuni: 1.2 × 10¹⁰ CFU/ml.
^{b}The actual time 0 was delayed by 5 to 10 seconds due to time for sample processing.
^{c}ND, not determined.
^{d}Negative by direct plating and enrichment culture.

### Example 2

Efficacy of the Organic Acid/SDS Compositions against L. monocytogenes: The efficacy of the antibacterial compositions disclosed herein was tested against Listeria monocytogenes using the same assay and procedures disclosed in Example 1. The results are indicated in Table 7.

TABLE 7
Reduction of L. monocytogenes by different concentrations of levulinic acid and SDS
individually and in combination at 21° C.

| | L. monocytogenes counts (log CFU/ml) at min: | | | | | |
|---|---|---|---|---|---|---|
| Chemical Treatment | 0^{a} | 2 | 5 | 10 | 20 | 30 |
| 0.5% levulinic acid (pH 3.1) | 6.7 ± 0.2 | 6.7 ± 0.1 | 6.8 ± 0.3 | 6.9 ± 0.2 | 6.7 ± 0.2 | 6.8 ± 0.2 |
| 1.0% levulinic acid (pH 3.0) | 6.8 ± 0.3 | 6.7 ± 0.2 | 6.6 ± 0.3 | 6.6 ± 0.3 | 6.6 ± 0.0 | 6.6 ± 0.3 |
| 1.5% levulinic acid (pH2.9) | 6.9 ± 0.1 | 6.9 ± 0.2 | 6.9 ± 0.3 | 6.9 ± 0.1 | 6.9 ± 0.3 | 6.8 ± 0.3 |
| 2.0% levulinic acid (pH 2.9) | 6.8 ± 0.3 | 6.8 ± 0.2 | 6.9 ± 0.2 | 6.7 ± 0.2 | 6.9 ± 0.2 | 6.8 ± 0.2 |
| 0.05% sodium dodecyl sulfate | 6.6 ± 0.3 | 6.4 ± 0.1 | 6.0 ± 0.1 | 5.0 ± 0.3 | 3.8 ± 0.2 | 3.3 ± 0.1 |
| (pH 4.8) | | | | | | |
| 0.5% levulinic acid + 0.05% SDS | −^{c} | − | − | − | − | − |
| (pH 3.0) | | | | | | |

^{a}The actual time 0 was delayed by 5 to 10 seconds due to time for sample processing.
^{b}+, Positive by enrichment culture but not by direct plating (minimum detection level is 0.7 log CFU/ml).
^{c}−, Negative by direct plating and enrichment culture.

### Example 3

Reduction of microorganisms by different chemical combination at 21° C.: Different combinations of pharmaceutically acceptable acids in combination with various pharmaceutically acceptable surfactants were tested for their antibacterial properties.

Microorganisms were contacted with the test compositions using the same assay and procedures as disclosed in Example 1. The results obtained by contacting microorganisms with different surfactant/acid combinations are indicated in Tables 8 and 9. As indicated by the following data, particularly Table 9, not all organic acids/surfactant combinations perform equivalently with regards to their efficacy as antimicrobial agents.

TABLE 8
Reduction of microorganisms by different chemical combination at 21° C.

| Chemical treatment | 0^{a} | 1 | 2 | 5 | 10 | 20 | 30 | 60 |
|---|---|---|---|---|---|---|---|---|
| | E. coli O157:H7 counts | | | | | | | |
| | (log CFU/ml) at min: | | | | | | | |
| E. coli O157:H7 only (Control) | 7.2 | 7.4 | ND^{b} | 7.3 | ND | ND | 7.3 | 7.4 |
| 0.05% SDS to pH 3.0 by 1N HCl | <0.7 | <0.7 | <0.7 | <0.7 | <0.7 | <0.7 | <0.7 | <0.7 |
| | S. enteritidis counts | | | | | | | |
| | (log CFU/ml) at min: | | | | | | | |
| S. enteritidis only (Control) | 7.2 | 7.1 | ND | 7.2 | ND | ND | 7.4 | 7.3 |
| 0.05% SDS to pH 3.0 by 1N HCl | <0.7 | <0.7 | <0.7 | <0.7 | <0.7 | <0.7 | <0.7 | <0.7 |
| | Y. pestis counts | | | | | | | |
| | (log CFU/ml) at min: | | | | | | | |
| Y. pestis only (Control) | 6.3 | 6.1 | 6.4 | 6.7 | 6.6 | 6.5 | 6.7 | 6.7 |
| 0.5% Levulinic acid plus | <0.7 | <0.7 | <0.7 | <0.7 | <0.7 | <0.7 | <0.7 | <0.7 |
| 0.05% SDS (pH 3.0) | | | | | | | | |

^{a}The actual time 0 was delayed by 5 to 10 seconds due to time for sample processing.
^{b}ND, not determined.
^{a}The actual time 0 may was delayed by 10 to 20 seconds due to time for sample processing.
^{b}+, Below the minimum detection level by direct plating (<0.7 log CFU/ml), but positive by enrichment culture.

### Example 4

### Treatment of Biofilms with Compositions Comprising an Acid and Surfactant

Preparation of stainless steel coupons: Coupons (4 cm×2.5 cm) composed of different materials, including stainless steel, polyvinyl chloride, nitrile rubber, glass, ultra-high molecular weight polyethylene were washed by a 10 min immersion with agitation (150 rpm) in 1000 ml of an aqueous 2% RBS 35 Detergent Concentrate solution (20 ml of RBS 35 Concentrate per liter of tap water at 50° C.; Pierce, Rockford, Ill.), and rinsed by immersion in 1000 ml of tap water (initial at 50° C.) with agitation (150 rpm) for 25 min. Five additional 1-min immersions with agitation (150 rpm) in 1000 ml of distilled water at ambient temperature were performed. The coupons were dried. The coupons were then individually wrapped and autoclaved at 121° C. for 30 min.
Biofilm formation of S. enteritidis on coupons: For purpose of a well-formatted biofilm of S. enteritidis on the surface of coupons, the coupons were placed individually in a 250-ml flask containing 100 ml tryptic soy broth (TSB) and an inoculum of 1.0 ml ca. 10⁸ CFU of a 5-strain mixture of S. enteritidis was added. The flasks were incubated at 37° C. for 24 h. The coupons then were removed individually and placed on the surface of a layer of paper tower for absorbing the extra fluid of the surface.

The coupons having the formed biofilms were then individually transferred to plates containing 30 ml chemical solution for treatment for 0, 1, 2, 5, 10, 20 min. Following treatment each coupon was placed in a 50-ml centrifuge tube containing 9.0 ml of PBS and 30 glass beads (5 mm). The tubes were agitated by a Vortex for 2 min to suspend the adherent bacteria. The suspended bacteria were serially diluted (1:10) in 0.1% peptone and plated in duplicate on TSA and XLD agar plates for S. enteritidis enumeration. The plates were incubated for 48 h at 37° C. and bacterial colonies counted.

Studies of S. enteritidis attached to the surface of the coupons revealed that the pathogen was eliminated in less than 1 minute by the treatment solution containing 3% levulinic acid plus 2% SDS (Tables 9 and 10).

TABLE 9
Reduction of S. enteritidis on stainless steel coupons by
levulinic acid plus SDS treatment at 21° C.

| Treatment | 0^{a} | 1 | 2 | 5 | 10 | 20 |
|---|---|---|---|---|---|---|
| | S. enteritidis counts (log CFU/cm²) with | | | | | |
| | coupons incubated for 2 h at min: | | | | | |
| PBS (7.2) (Control) | 7.4 | 7.3 | ND^{b} | 7.3 | ND | 7.4 |
| 3% levulinic acid + | <0.7 | <0.7 | <0.7 | <0.7 | <0.7 | <0.7 |
| 2% SDS (pH 2.7) | | | | | | |
| | S. enteritidis counts (log CFU/cm²) with | | | | | |
| | coupons incubated for 4 h at min: | | | | | |
| | <0.7 | <0.7 | <0.7 | <0.7 | <0.7 | <0.7 |
| | S. enteritidis counts (log CFU/cm²) with | | | | | |
| | coupons incubated for 24 h at min: | | | | | |
| | <0.7 | <0.7 | <0.7 | <0.7 | <0.7 | <0.7 |

^{a}The actual time 0 may was delayed by 15 to 25 seconds due to time for sample processing
^{b}Not determined

TABLE 10
Chemical inactivation of S. enteritidis in biofilm at 21° C. by 3%
levulinic acid plus 2% sodium dodecyl sulfate (SDS)

| | | S. enteritidis count | | | |
|---|---|---|---|---|---|
| | | (log CFU/cm2) at minutes | | | |
| Type of Coupon | Treatment Solution | 0 | 1 | 5 | 10 |
| Stainless | PBS, pH 7.2 | 8.0 | 8.4 | 8.6 | 8.2 |
| | NaClO₂ (500 ppm), pH | 7.5 | 5.9 | 5.4 | 6.2 |
| | 2.8 | | | | |
| | 3.0% levulinic acid (LV) | <0.7 | <0.7 | <0.7 | <0.7 |
| | plus 2.0% SDS, pH 3.0 | | | | |
| Polyvinyl | PBS | 8.8 | 9.0 | 8.8 | 8.0 |
| chloride | NaClO₂ (500 ppm) | 6.9 | 5.5 | 5.3 | 4.2 |
| | 3.0% LV plus 2.0% SDS | 2.3 | 1.7 | 2.2 | <0.7 |
| Nitrile rubber | PBS | 7.8 | 8.0 | 7.7 | 7.9 |
| | NaClO₂ (500 ppm) | 7.2 | 5.2 | 2.6 | 1.3 |
| | 3.0% LV plus 2.0% SDS | 4.1 | 1.7 | <0.7 | <0.7 |
| Glass | PBS | 8.2 | 8.7 | 8.4 | 8.4 |
| | NaClO₂ (500 ppm) | 6.8 | 3.3 | <0.7 | <0.7 |
| | 3.0% LV plus 2.0% SDS | <0.7 | <0.7 | <0.7 | <0.7 |
| Ultra-high | PBS | 8.4 | 8.4 | 8.4 | 8.4 |
| molecular weight | NaClO₂ (500 ppm) | 6.8 | 6.1 | <0.7 | <0.7 |
| polyethylene | 3.0% LV plus 2.0% SDS | <0.7 | <0.7 | <0.7 | <0.7 |

### Example 5

Efficacy of compositions to kill spores of Bacillus anthracis Sterne: For all experiments an equal volume of spore suspension of B. anthracis Sterne (34F₂) was added to 25 ml of reagents A, B, C, D, E, and F in 250-ml flasks. The compositions of reagents are A: 3% levulinic acid plus 2% SDS; B: 2% levulinic acid plus 1% SDS; C, 0.5% levulinic acid plus 0.05% SDS; D: 3% levulinic acid; E: 2% SDS; F: water (control).

Flasks were incubated at 37° C. in a shaker (200 rpm). At each time point 100 μl of sample was transferred into 900 μl water, vortexed, and 100 μl of the dilution spread on Brain Heart Infusion agar plates. Plates were incubated at 37° C. over night and colonies counted the next morning (approximately 16 hours later).

Experiment 1: 250 μl spore suspension (5×10⁴ spores) were added to 25 ml of the reagents. Sampling time points were t0 (spores were added and after mixing with the reagent, 100 μl of the suspension were removed for enumeration), t10 min, t45 min, t90 min, t180 min. Average plate counts (FIGS. 18A-18E) are based on counting three plates; error bars indicate +/− one standard deviation.

At t45 min recovery of CFUs from flasks A and B was reduced to 9% (1.7 CFU) and 43% (8 CFU), respectively, as compared to control flask F. At t90 min and t180 min zero colony forming units (CFU) were recovered from flasks A and B. For flasks C and D retrieval decreased over time but did not drop below 16% (reagent C) and 39% (reagent D) at 180 min. Recovery levels from the flask with reagent E did not decrease (Table 11).

TABLE 11
Experiment A3: CFU % recovery (as compared to control flask F)

| | 0 min | 10 min | 45 min | 90 min | 180 min |
|---|---|---|---|---|---|
| A | 85 | 81 | 9 | 0 | 0 |
| B | 121 | 66 | 43 | 0 | 0 |
| C | 142 | 77 | 82 | 48 | 16 |
| D | 108 | 81 | 55 | 64 | 39 |
| E | 119 | 65 | 94 | 144 | 95 |
| F | 100 | 100 | 100 | 100 | 100 |

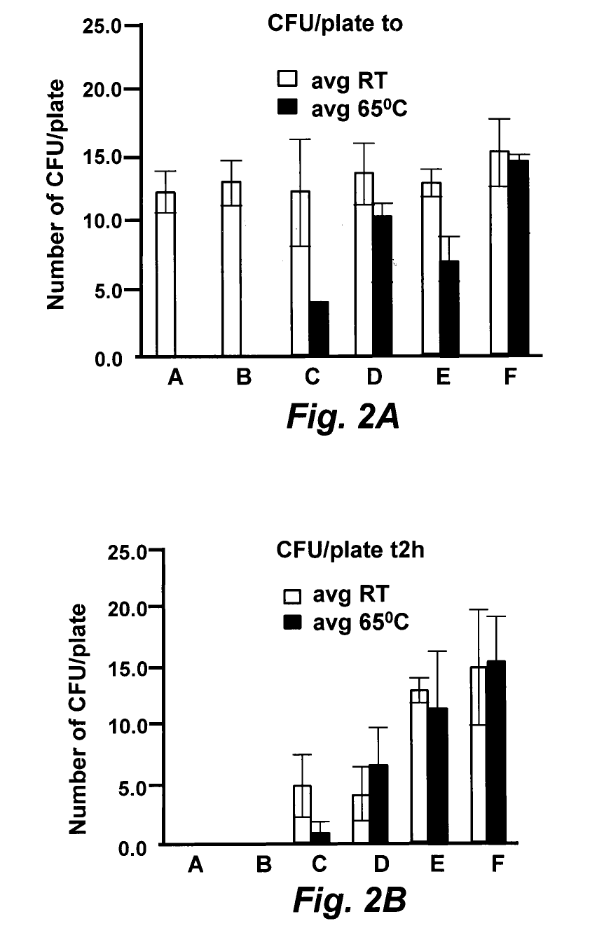

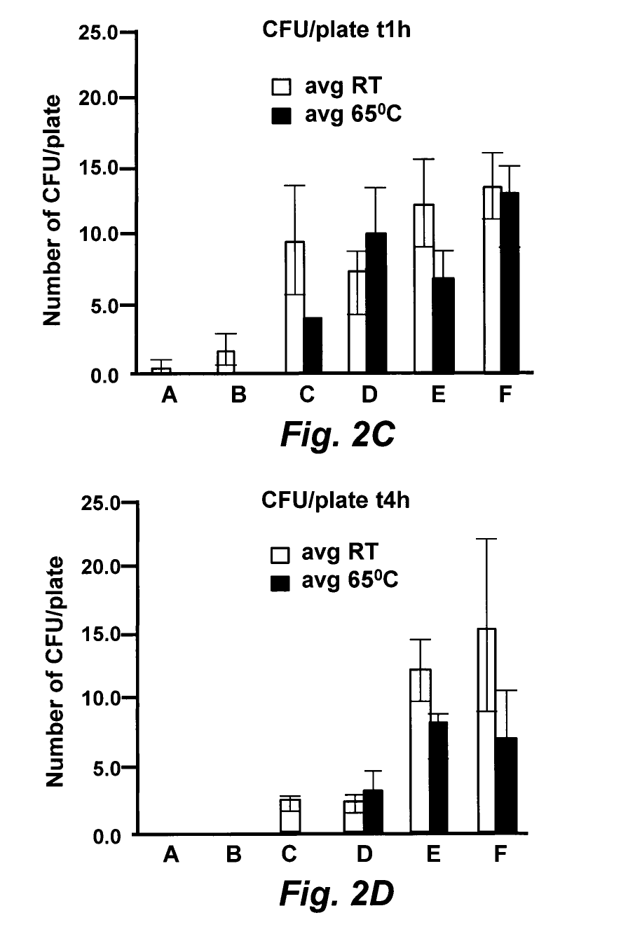

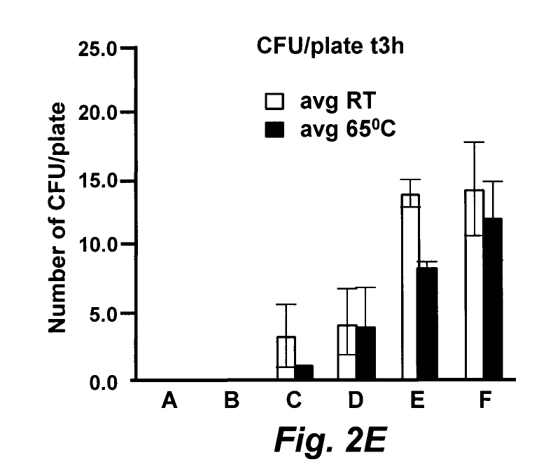

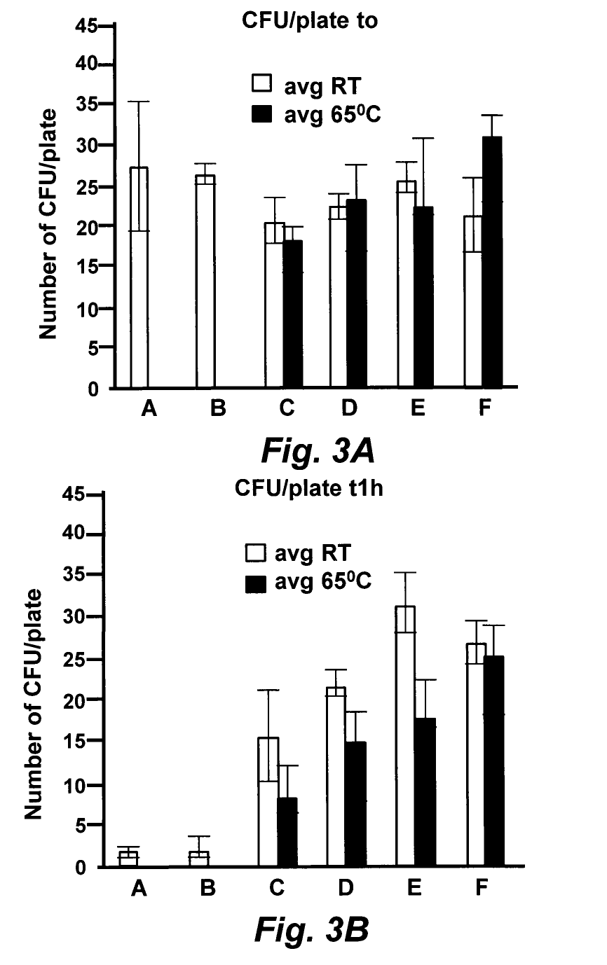

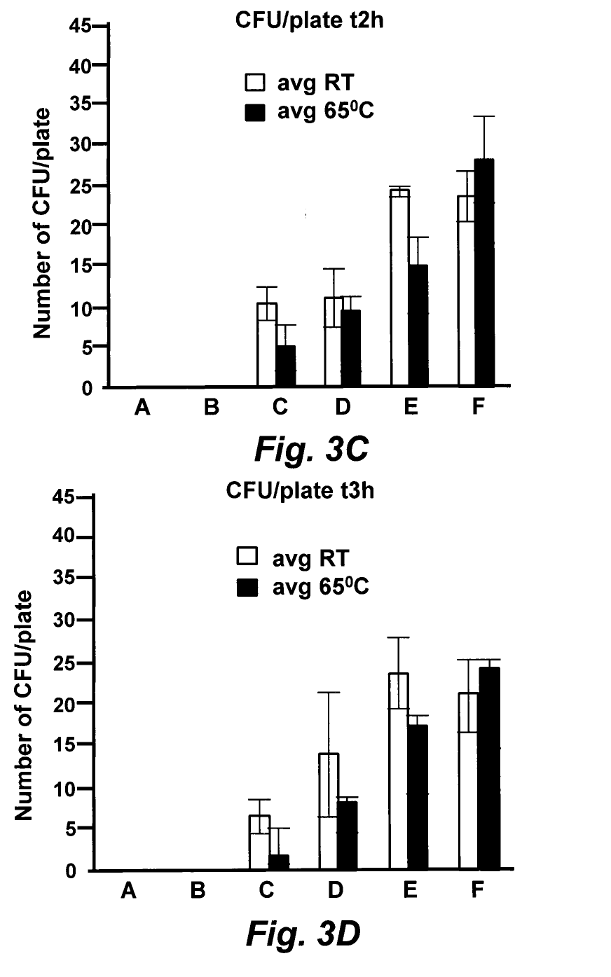

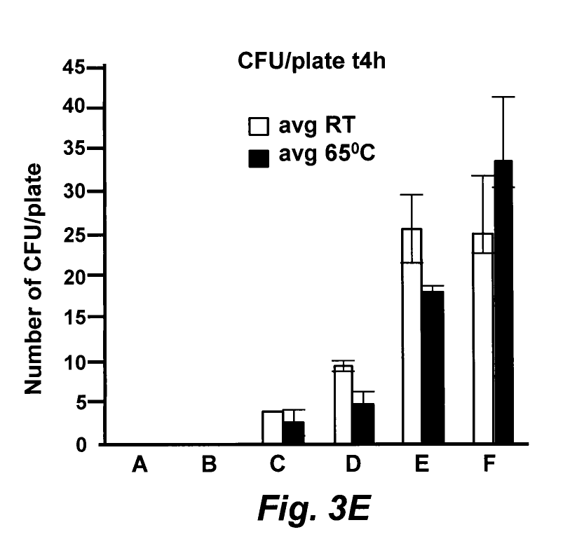

Experiments 2 and 3: 250 μl spore suspension (5×10⁴ spores) were added to 25 ml of the reagents. In experiment A5, 625 μl spore suspension (1.25×10⁵ spores) were added to 25 ml of the reagents. Sampling time points were t0, t1h, t2h, t3h, t4h, t5h. In order to differentiate whether CFU originated from vegetative cells or from spores, at each time point samples were split in two equivalent aliquots. One aliquot was subjected to heat treatment (65° C., 30 min) to kill vegetative cells before enumeration of residual heat-resistant spores. The other aliquot was plated at room temperature (RT). Average plate counts (FIGS. 2A-2E and 3A-3E, respectively) are based on counting three plates; error bars indicate +/− one standard deviation.

In both experiments CFU recovery from flasks A and B at t0 and t1h originated from heat-sensitive cells because colony counts were zero for the samples which received heat treatment. No CFU were retrieved from flask A or B for t=2h, t=3h, t=4h (FIGS. 2A-2E and 3A-3E). For both reagents C and D % recovery decreased over time but of all compounds tested reagents A and B killed most effectively (Tables 12, 13, 14, 15). Reagent E was not more effective than the water control F (FIGS. 2A-2E and 3A-3E).

TABLE 12
Experiment A4 absent heat: CFU % recovery
(as compared to control flask F): RT

| | 0 min | 1 h | 2 h | 3 h | 4 h |
|---|---|---|---|---|---|
| A | 81 | 2 | 0 | 0 | 0 |
| B | 85 | 12 | 0 | 0 | 0 |
| C | 81 | 71 | 33 | 23 | 15 |
| D | 89 | 54 | 27 | 30 | 15 |
| E | 85 | 90 | 87 | 98 | 79 |
| F | 100 | 100 | 100 | 100 | 100 |

TABLE 13
Experiment A4 with heat: CFU % recovery
(as compared to control flask F): 65° C.

| | 0 min | 1 h | 2 h | 3 h | 4 h |
|---|---|---|---|---|---|
| A | 0 | 0 | 0 | 0 | 0 |
| B | 0 | 0 | 0 | 0 | 0 |
| C | 27 | 13 | 6 | 8 | 0 |
| D | 70 | 78 | 45 | 33 | 46 |
| E | 48 | 53 | 74 | 68 | 114 |
| F | 100 | 100 | 100 | 100 | 100 |

TABLE 14
Experiment A5 absent heat: CFU % recovery
(as compared to control flask F): RT

| | 0 min | 1 h | 2 h | 3 h | 4 h |
|---|---|---|---|---|---|
| A | 128 | 6 | 0 | 0 | 0 |
| B | 124 | 6 | 0 | 0 | 0 |
| C | 97 | 58 | 44 | 32 | 16 |
| D | 105 | 80 | 46 | 67 | 37 |
| E | 122 | 117 | 103 | 113 | 103 |
| F | 100 | 100 | 100 | 100 | 100 |

TABLE 15
Experiment A5 with heat: CFU % recovery
(as compared to control flask F): 65° C.

| | 0 min | 1 h | 2 h | 3 h | 4 h |
|---|---|---|---|---|---|
| A | 0 | 0 | 0 | 0 | 0 |
| B | 0 | 0 | 0 | 0 | 0 |
| C | 58 | 32 | 18 | 8 | 8 |
| D | 75 | 58 | 34 | 34 | 14 |
| E | 71 | 69 | 53 | 71 | 54 |
| F | 100 | 100 | 100 | 100 | 100 |

While reagents C and D in a 4-hour time frame had a negative effect on spore survival, neither one of these reagents was as effective in killing spores as reagents A and B. Reagent E was not different from the water control F.

Viable cell counts demonstrated that reagents A and B affected heat sensitivity of spores very quickly at the t=0 time point suggesting induction of a break in spore dormancy. Chemical disinfectants which are not toxic and able to diminish resistance of spores to killing are potentially of great benefit.

### Example 6

Isolates: Bacillus subtilis strain ATCC #82 and B. cereus ATCC#10987 were obtained from ATCC, and B. circulans #47-10 and #31028 were from collection at Center for Food Safety. The frozen isolates were grown in brain heart infusion agar (BHA) at 37° C. for 24 h. Alicyclobacillus acidocaldarius strain OS-CAJ and SAC (isolated from apple juice concentrate), and N-1108 (isolated from apple-cranberry juice) were from collection at Center for Food Safety. The isolated were grown in Orange Serum Broth at 43° C. for 72 h and then transferred to potato dextrose agar (PDA) at 43° C. for 48 h.
Spore production: For B. cereus, B. subtilis, and B. circulans, the isolates were individually grown in 10-ml BHI for 24 hours and then, precipitated, suspended and washed for 3 times by centrifugation at 4,000×g for 20 min. The final pellet was transferred to 10-ml sporulation medium, containing FeCl₂, 0.0036 mM; MgCl₂, 0.041 mM; MnCl₂, 0.1 mM; NH₄Cl, 10 mM; Na₂SO₄, 0.75 mM; KH₂PO₄, 0.5 mM; CaCl₂, 1 mM; NH₄NO₃, 1.2 mM; D-glucose, 10 mM; and L-glutamic acid, 10 mM, pH 7.1 (Donnellan et al., (1964) J. Bact. 87: 332-335) at 30° C. for 5 days with agitation at 200 RPM. The spores were precipitated and suspended in 1-ml sterile H₂O by centrifugation at 4,000×g for 20 min. The solution was heated at 65° C. for 30 min and kept at 4° C. before use. For A. acidoterrestris isolates, the bacterium was individually grown in potato dextrose agar, pH 3.5 at 43° C. for 7 days and bacteria were collected by a plastic loop, suspended in 5-ml sterile H₂O containing 30 glass beads and vortexed for 2 min at 150 rpm. The solution was heated at 65° C. for 30 min and kept in 5° C. before use.
Spore staining: The Wirtz-Conklin spore stain was used for observation of spore morphology.
Chemicals: Levulinic acid and sodium dodecyl sulfate were obtained from Sigma-Aldrich (St. Louis, Mo.).
Water Deionized, unchlorinated water was filter sterilized through a 0.2-μm regenerated cellulose filter (Corning Inc., Corning, N.Y.) was used for preparing chemical solution.
Inactivation of spores: Each 500-ml flasks containing 199-ml combined chemical solution with a magnetic bar at 200 rpm was individually heated to 62° C. ±2° C. in a hot plate. A volume of 1.0-ml spore was added in the center of the chemical solution under constant mixing condition at 200 rpm.
Enumeration of spores: At pre-determined schedules a sample of 1.0-ml was removed from the flask and mixed with 9.0-ml 0.1 M phosphate buffer, pH 7.2 and then serial dilution (1:10) up to 10⁻⁸ CFU/ml was made and 0.1-ml from each diluted tubes was inoculated on the surface of either BHA plates for bacillus species or PDA plates for alicyclobacillus species. The plates were incubated at 37° C., 48 h for bacillus and at 43° C., 72 h for alicyclobacillus species. The species of colonies randomly picked from the highest dilution plates were confirmed by biochemical assays.

### Example 7

TABLE 16
Counts of B. subtilis (strain) ATCC #82 spores treated by
levulinic acid and sodium dodecyl sulfate at 21° C.

| | 0.5% levulinic | | 3% levulinic | |
|---|---|---|---|---|
| | acid + | 2% levulinic acid + | acid + | H₂O |
| Timing | 0.05% SDS | 1% SDS | 2% SDS | only |
| (min) | Counts of spores (log CFU/ml) | | | |
| 0 | <0.7 | <0.7 | <0.7 | 5.5 ± 0.3 |
| 1 | <0.7 | <0.7 | <0.7 | 5.3 ± 0.1 |
| 2 | <0.7 | <0.7 | <0.7 | 5.4 ± 0.1 |
| 5 | <0.7 | <0.7 | <0.7 | 5.4 ± 0.1 |
| 10 | <0.7 | <0.7 | <0.7 | 5.3 ± 0.3 |
| 20 | <0.7 | <0.7 | <0.7 | 5.5 ± 0.1 |
| 30 | <0.7 | <0.7 | <0.7 | 5.3 ± 0.2 |
| 60 | <0.7 | <0.7 | <0.7 | 5.4 ± 0.1 |

^{a}Inoculation of spore is 5.0 × 10⁷ CFU/ml after heating at 65° C. for 30 min.

### Example 8

TABLE 17
Counts of B. subtilis (strain ATCC #31028) spores treated by
levulinic acid and sodium dodecyl sulfate at 21° C.

| | 3% levulinic | | 3% levulinic acid + | H₂O |
|---|---|---|---|---|
| Timing | acid + 2% SDS | H₂O only | 2% SDS | only |
| (min) | Counts of spores (log CFU/ml) | | | |
| 1 | 6.2 ± 0.2 | 7.0 ± 0.1 | 5.8 ± 0.1 | 6.4 ± 0.2 |
| 3 | 6.2 ± 0.1 | ND | 5.9 ± 0.2 | ND |
| 5 | 6.1 ± 0.4 | ND | 5.8 ± 0.2 | ND |
| 10 | 6.1 ± 0.2 | ND | 5.7 ± 0.0 | ND |
| 20 | 6.1 ± 0.3 | ND | 5.8 ± 0.1 | ND |
| 30 | 5.9 ± 0.2 | ND | 5.7 ± 0.2 | ND |
| 60 | 6.2 ± 0.2 | ND | 5.8 ± 0.2 | ND |
| 90 | 6.2 ± 0.1 | ND | 5.8 ± 0.1 | ND |
| 120 | 6.3 ± 0.3 | 7.1 ± 0.3 | 5.8 ± 0.5 | 6.4 ± 0.3 |

^{a}Inoculation of spore is 2.7 × 10⁸ CFU/ml after heating at 65° C. for 30 min.

### Example 9

TABLE 18
Counts of B. subtilis (strain ATCC #31028) spores treated by
levulinic acid and sodium dodecyl sulfate at 21° C.

| | | |
|---|---|---|
| | 10% levulinic acid + | H₂O |
| Timing | 2% SDS | only |

| | |
|---|---|
| (min) | Counts of spores (log CFU/ml) |

| | | |
|---|---|---|
| 5 | 6.2 ± 0.1 | 6.5 ± 0.3 |
| 10 | 5.9 ± 0.2 | ND |
| 30 | 6.0 ± 0.2 | ND |
| 60 | 6.2 ± 0.1 | ND |
| 120 | 6.1 ± 0.3 | ND |
| 180 | 6.2 ± 0.2 | ND |
| 240 | 6.1 ± 0.1 | 6.4 ± 0.2 |

### Example 10

TABLE 19
Counts of B. subtilis (strain ATCC #31028) spores treated by
levulinic acid and sodium dodecyl sulfate at 21° C.

| | | |
|---|---|---|
| | 20% levulinic acid + | H₂O |
| Timing | 3% SDS | only |

| | |
|---|---|
| (min) | Counts of spores (log CFU/ml) |

| | | |
|---|---|---|
| 5 | 6.0 ± 0.1 | 6.6 ± 0.3 |
| 15 | 6.1 ± 0.2 | ND |
| 30 | 5.9 ± 0.2 | ND |
| 60 | 6.0 ± 0.3 | ND |
| 90 | 5.8 ± 0.2 | ND |
| 120 | 5.6 ± 0.2 | 6.2 ± 0.5 |

### Example 11

TABLE 20
Counts of B. subtilis (strain ATCC #31028) spores treated by
levulinic acid and sodium dodecyl sulfate at 62° C.

| | | |
|---|---|---|
| | 3% levulinic acid + | H₂O |
| Timing | 2% SDS | only |

| | |
|---|---|
| (min) | Counts of spores (log CFU/ml) |

| | | |
|---|---|---|
| 1 | <0.7 | ND |
| 5 | <0.7 | ND |
| 15 | <0.7 | ND |
| 30 | <0.7 | ND |
| 60 | <0.7 | 5.0 ± 0.0 |

^{a}Inoculums of B. subtilis ATCC #31028 is 1.6 × 10⁹/ml (germinated and spores).

### Example 12

TABLE 21
Counts of B. circulans (strain #47-10) spores treated by
levulinic acid and sodium dodecyl sulfate at 21° C.

| | | |
|---|---|---|
| | 0.5% levulinic acid + | H₂O |
| Timing | 0.05% SDS | only |

| | |
|---|---|
| (min) | Counts of spores (log CFU/ml) |

| | | |
|---|---|---|
| 0 | 2.2 ± 0.3 | 4.3 ± 0.4 |
| 1 | 2.4 ± 0.1 | ND |
| 2 | 1.9 ± 0.3 | ND |
| 5 | 2.1 ± 0.1 | 4.4 ± 0.1 |
| 10 | 2.1 ± 0.2 | ND |
| 20 | 1.6 ± 0.0 | ND |
| 30 | 1.0 ± 0.0 | 4.6 ± 0.1 |
| 60 | 1.3 ± 0.0 | 4.5 ± 0.2 |

^{a}Inoculation of spore is 8.8 × 10⁶ CFU/ml after heating at 65° C. for 30 min.

### Example 13

TABLE 22
Counts of B. circulans (strain #47-10) spores treated by levulinic
acid and sodium dodecyl sulfate at 21° C.

| | | |
|---|---|---|
| | 3% levulinic acid + 2% | H₂O |
| Timing | SDS | only |

| | |
|---|---|
| (min) | Counts of spores (log CFU/ml) |

| | | |
|---|---|---|
| 1 | 5.2 ± 0.2 | 6.2 ± 0.2 |
| 3 | 5.5 ± 0.1 | ND |
| 5 | 5.0 ± 0.2 | ND |
| 10 | 5.1 ± 0.1 | ND |
| 20 | 5.2 ± 0.2 | ND |
| 30 | 5.2 ± 0.1 | ND |
| 60 | 4.9 ± 0.1 | ND |
| 90 | 4.6 ± 0.1 | ND |
| 120 | 4.4 ± 0.1 | ND |

^{a}Inoculation of spore is 8.2 × 10⁸ CFU/ml after heating at 65° C. for 30 min.

### Example 14

TABLE 23
Counts of B. circulans (strain #47-10) spores treated by levulinic
acid and sodium dodecyl sulfate at 21° C.

| | | |
|---|---|---|
| | 3% levulinic acid + | H₂O |
| Timing | 2% SDS | only |

| | |
|---|---|
| (min) | Counts of spores (log CFU/ml) |

| | | |
|---|---|---|
| 1 | 4.5 ± 0.2 | 5.0 ± 0.2 |
| 3 | 4.5 ± 0.3 | ND |
| 5 | 4.6 ± 0.2 | ND |
| 10 | 4.6 ± 0.1 | ND |
| 20 | 4.5 ± 0.1 | ND |
| 30 | 4.6 ± 0.0 | ND |
| 60 | 4.5 ± 0.0 | ND |
| 90 | 4.4 ± 0.0 | ND |
| 120 | 4.0 ± 0.1 | 5.0 ± 0.2 |

^{a}Inoculation of spore is 9.8 × 10⁶ CFU/ml after heating at 65° C. for 30 min.

### Example 15

TABLE 24
Counts of B. circulans (strain #47-10) spores treated by levulinic
acid and sodium dodecyl sulfate at 21° C.

| | | |
|---|---|---|
| | 10% levulinic acid + | H₂O |
| Timing | 2% SDS | only |

| | |
|---|---|
| (min) | Counts of spores (log CFU/ml) |

| | | |
|---|---|---|
| 5 | 5.0 ± 0.1 | 5.0 ± 0.2 |
| 10 | 4.9 ± 0.1 | ND |
| 30 | 4.3 ± 0.2 | ND |
| 60 | 3.5 ± 0.0 | ND |
| 120 | 2.8 ± 0.1 | ND |
| 180 | <0.7 | ND |
| 240 | <0.7 | 5.0 ± 0.2 |

^{a}Inoculation of spore is 9.3 × 10⁶ CFU/ml after heating at 65° C. for 30 min.

### Example 16

TABLE 25
Counts of B. cereus (strain ATCC#10987) spores treated by levulinic
acid and sodium dodecyl sulfate at 21° C.

| | | |
|---|---|---|
| | 0.5% levulinic acid + | H₂O |
| Timing | 0.05% SDS | only |

| | |
|---|---|
| (min) | Counts of spores (log CFU/ml) |

| | | |
|---|---|---|
| 0 | 4.8 ± 0.1 | 4.8 ± 0.1 |
| 1 | 4.8 ± 0.3 | ND |
| 2 | 4.7 ± 0.1 | ND |
| 5 | 4.4 ± 0.3 | 4.8 ± 0.2 |
| 10 | 4.2 ± 0.4 | ND |
| 20 | 3.8 ± 0.2 | ND |
| 30 | 3.8 ± 0.1 | 4.9 ± 0.1 |
| 60 | 3.7 ± 0.1 | 4.8 ± 0.2 |

^{a}Inoculation of spore is 2.2 × 10⁷ CFU/ml after heating at 65° C. for 30 min.

### Example 17

TABLE 26
Counts of B. cereus (strain ATCC#10987) spores treated by
levulinic acid and sodium dodecyl sulfate at 21° C.

| | | |
|---|---|---|
| | 3% levulinic acid + | H₂O |
| Timing | 2% SDS | only |

| | |
|---|---|
| (min) | Counts of spores (log CFU/ml) |

| | | |
|---|---|---|
| 1 | 6.5 ± 0.1 | 6.7 ± 0.1 |
| 3 | 6.5 ± 0.2 | ND |
| 5 | 6.7 ± 0.1 | ND |
| 10 | 6.5 ± 0.1 | ND |
| 20 | 6.4 ± 0.1 | ND |
| 30 | 6.7 ± 0.2 | ND |
| 60 | 6.7 ± 0.1 | ND |
| 90 | 6.7 ± 0.1 | ND |
| 120 | 6.7 ± 0.1 | 7.1 ± 0.2 |

^{a}Inoculation of spore is 4.0 × 10⁸ CFU/ml after heating at 65° C. for 30 min.

### Example 18

TABLE 27
Counts of B. cereus (strain ATCC#10987) spores treated by levulinic
acid and sodium dodecyl sulfate at 21° C.

| | 10% levulinic | H₂O | 20% levulinic | H₂O |
|---|---|---|---|---|
| | acid + 2% SDS | only | acid + 3% SDS | only |
| Timing (min) | Counts of spores (log CFU/ml) | | | |
| 5 | 6.2 ± 0.4 | 6.6 ± 0.1 | 6.3 ± 0.3 | 6.7 ± 0.2 |
| 10 | 6.6 ± 0.1 | ND | ND | ND |
| 15 | ND | ND | 6.3 ± 0.2 | ND |
| 30 | 6.1 ± 0.2 | ND | 6.3 ± 0.1 | ND |
| 60 | 6.3 ± 0.3 | ND | 6.3 ± 0.2 | ND |
| 90 | ND | ND | 6.2 ± 0.2 | ND |
| 120 | 6.3 ± 0.0 | ND | 6.0 ± 0.1 | 6.5 ± 0.3 |
| 180 | 6.2 ± 0.1 | ND | 5.8 ± 0.1 | ND |
| 240 | 6.6 ± 0.0 | 6.7 ± 0.2 | ND | ND |

^{a}Inoculation of spore is 6.1 × 10⁸ CFU/ml after heating at 65° C. for 30 min.

### Example 19

TABLE 28
Counts of B. cereus spores treated by levulinic acid and sodium
dodecyl sulfate at 62° C. ± 2° C.

| | | 3% levulinic acid + 2% SDS | H₂O only |
|---|---|---|---|
| | Timing | at 62° C. | at 62° C. |
| Strain | (min) | Counts of spores (log CFU/ml) | |
| B. cereus | 0 | <0.7 | 6.1 ± 0.1 |
| (ATCC#10987) | 1 | <0.7 | ND |
| | 5 | <0.7 | ND |
| | 20 | <0.7 | ND |
| | 30 | <0.7 | ND |
| | 60 | <0.7 | 5.7 ± 0.1 |
| B. circulans | 0 | <0.7 | 4.5 ± 0.3 |
| (#47-10) | 1 | <0.7 | ND |
| | 2 | <0.7 | ND |
| | 5 | <0.7 | ND |
| | 10 | <0.7 | ND |
| | 20 | <0.7 | 3.7 ± 0.1 |

### Example 20

TABLE 29
Counts of Alicyclobacillus acidoterrestris mixture (bacteria + spores)
treated by levulinic acid and sodium dodecyl sulfate at 62° ± 2° C.

| | | 3% levulinic acid + 2% SDS | H₂O at |
|---|---|---|---|
| | Timing | at 62° C. | 62° C. |
| Strain | (min) | Counts of spores (log CFU/ml) | |
| #SAC, #OS- | 0 | <0.7 | 6.5 ± 0.1 |
| CAS, and #N- | 10 | <0.7 | 6.1 ± 0.1 |
| 1108 | 30 | <0.7 | 4.6 ± 0.2 |
| | 60 | <0.7 | 3.8 ± 0.1 |

^{a}Inoculation of a mixture of 3-strains A. acidoterrestris, including strains #SAC, #OS-CAS, and #N-1108 is 1.1 × 10⁹/ml.

### Example 21

TABLE 30
Counts of Alicyclobacillus acidoterrestris mixture (bacteria +
spores) treated by levulinic acid and sodium dodecyl sulfate at 21° C.
and 62° C.

| | | 3% levulinic | | | |
|---|---|---|---|---|---|
| | | acid + | | 3% levulinic | |
| | | 2% SDS | H₂O only | acid + 2% SDS | H₂O only |
| | Timing | at 21° C. | at 21° C. | at 62° C. | at 62° C. |
| Strain | (min) | Counts of spores (log CFU/ml) | | | |
| SAC | 0 | 4.7 ± 0.2 | 4.8 ± 0.1 | ND | ND |
| | 1 | ND | ND | <0.7 | 5.0 ± 0.2 |
| | 5 | ND | ND | <0.7 | 5.1 ± 0.2 |
| | 10 | ND | ND | <0.7 | 5.1 ± 0.1 |
| | 30 | 4.6 ± 0.2 | ND | ND | ND |
| | 60 | 4.7 ± 0.2 | 4.8 ± 0.1 | ND | ND |
| OS-CAJ | 0 | 4.5 ± 0.1 | 4.9 ± 0.1 | ND | ND |
| | 1 | ND | ND | <0.7 | 5.0 ± 0.1 |
| | 5 | ND | ND | <0.7 | 5.0 ± 0.3 |
| | 10 | ND | ND | <0.7 | 5.2 ± 0.2 |
| | 30 | 4.4 ± 0.1 | ND | ND | ND |
| | 60 | 4.1 ± 0.2 | 4.9 ± 0.1 | ND | ND |
| N-1108 | 0 | 4.8 ± 0.1 | 5.1 ± 0.2 | ND | ND |
| | 1 | ND | ND | <0.7 | 5.0 ± 0.1 |
| | 5 | ND | ND | <0.7 | 5.1 ± 0.1 |
| | 10 | ND | ND | <0.7 | 5.1 ± 0.0 |
| | 30 | 4.8 ± 0.1 | ND | ND | ND |
| | 60 | 3.9 ± 0.2 | 5.1 ± 0.1 | ND | ND |

^{a}Inoculation of mixture for isolate SAC is 1.6 × 10⁸ CFU/ml, for OS-CAS is 2.6 × 10⁷ CFU/ml, and for N-1108 is 6.3 × 10⁷ CFU/ml.

### Example 22

TABLE 31
Counts of Alicyclobacillus acidoterrestris spores (pre-treated for
30 min at 65° C.)

Counts of A. acidoterrestris (log
CFU/ml)

| Bacterial | Timing | 3% levulinic acid + | |
|---|---|---|---|
| isolates | (Sec) | 2% SDS at 62° C. | H₂O at 62° C. |
| SAC | 0 | 4.3 | |
| | 15 | 4.3 | |
| | 30 | 3.4 | |
| | 60 | 3.3 | |
| | 90 | 2.7 | |
| | 300 | | 5.2 |
| OS-CAJ | 0 | 4.3 | |
| | 15 | 4.3 | |
| | 30 | 4.4 | |
| | 60 | 4.0 | |
| | 90 | 3.4 | |
| | 300 | | 5.4 |
| N-1108 | 0 | 4.2 | |
| | 15 | 4.5 | |
| | 30 | 4.4 | |
| | 60 | 4.2 | |
| | 90 | 3.7 | |
| | 300 | | 5.3 |

^{a}Inoculation of spore (after treated at 65° C. for 30 min) for isolate SAC is 8.0 × 10⁷ CFU/ml, for OS-CAS is 7.2 × 10⁷ CFU/ml, and for N-1108 is 6.3 × 10⁷ CFU/ml.

TABLE 32
Effect of levulinic acids plus Sodium Dodecyl Sulfate (SDS) at different
concentrations at 21° C. on various yeast species

| | Yeast counts (log CFU/ml) at min: | | | | | | | |
|---|---|---|---|---|---|---|---|---|
| Yeast Name^{a} | 0^{b} | 1 | 2 | 5 | 10 | 20 | 30 | 60 |
| Saccharomyces cerevisiae in 0.1M PBS | 5.2 | 5.3 | 5.5 | 5.3 | 5.3 | 5.2 | 5.3 | 5.3 |
| (Control) | | | | | | | | |
| Saccharomyces cerevisiae in 2.0% | 5.4 | 5.3 | 5.5 | 5.4 | 5.3 | 5.3 | 5.5 | 5.0 |
| levulinic acid (Control) | | | | | | | | |
| S. cerevisiae in 1.0% SDS (Control) | 2.7 | 2.4 | 2.6 | 2.3 | 2.8 | 2.7 | 2.3 | 2.4 |
| S. cerevisiae in 0.5% levulinic + 0.05% | 4.9 | 4.5 | 3.9 | 3.2 | 2.7 | 1.7 | 1.3 | <0.7 |
| SDS | | | | | | | | |
| S. cerevisiae in 2% levulinic acid + 1.0% | 0.7 | — | — | — | — | — | — | — |
| SDS | | | | | | | | |
| Debaryomyces hansenii in 0.1M PBS | 4.8 | 4.9 | 4.9 | 4.8 | 4.8 | 4.8 | 4.8 | 4.8 |
| (Control) | | | | | | | | |
| D. hansenii in 2.0% levulinic acid (Control) | 4.9 | 4.8 | 4.9 | 4.6 | 4.4 | 4.7 | 3.0 | 1.3 |
| D. hansenii in 1.0% SDS (Control) | 4.5 | 4.5 | 4.1 | 4.5 | 4.4 | 4.5 | 4.5 | 4.4 |
| D. hansenii in 0.5% levulinic acid + 0.05% | 4.9 | 4.9 | 4.7 | 4.5 | 4.3 | 3.7 | 3.1 | 1.7 |
| SDS | | | | | | | | |
| D. hansenii 2% levulinic acid + 1% SDS | 1.0 | — | — | — | — | — | — | — |
| Candida magnoliae in 0.1M PBS (Control) | 5.9 | 5.8 | 6.1 | 5.9 | 5.9 | 5.9 | 5.9 | 5.7 |
| C. magnoliae in 2.0% levulinic acids | 6.0 | 5.9 | 5.9 | 5.9 | 6.0 | 6.0 | 5.9 | 5.8 |
| (Control) | | | | | | | | |
| C. magnoliae in 1.0% SDS (Control) | 3.5 | 3.5 | 3.3 | 3.2 | 3.2 | 2.7 | 3.0 | 3.1 |
| C. magnoliae in 0.5% levulinic acids + | 4.0 | 3.6 | 3.2 | 2.1 | 1.3 | <0.7 | <0.7 | <0.7 |
| 0.05% SDS | | | | | | | | |
| C. magnoliae in 2.0% levulinic acid + 1.0% | 2.1 | 0.7 | — | — | — | — | — | — |
| SDS | | | | | | | | |
| Zygosaccharomyces bailii in 0.1M PBS | 5.4 | 5.5 | 5.6 | 5.5 | 5.3 | 5.4 | 5.6 | 5.5 |
| (Control) | | | | | | | | |
| Z. bailii in 2% levulinic acid (Control) | 5.4 | 5.4 | 5.5 | 5.4 | 5.4 | 5.4 | 5.4 | 5.3 |
| Z. bailii in 1.0% SDS (Control) | 4.6 | 4.7 | 4.6 | 4.6 | 4.6 | 4.5 | 4.5 | 4.4 |
| Z. bailii in 0.5% levulinic acid + 0.05% SDS | 5.0 | 5.0 | 4.8 | 3.6 | 3.8 | 2.3 | 2.6 | <0.7 |
| Z. bailii in 2% levulinic acid + 1% SDS | 4.6 | 4.2 | 3.9 | 2.9 | 2.0 | <0.7 | <0.7 | <0.7 |
| Geotrichum candidum 0.1M PBS (Control) | 4.6 | 4.7 | 4.8 | 4.7 | 4.7 | 4.5 | 4.6 | 4.6 |
| G. candidum in 2.0% levulinic acid | 4.6 | 4.4 | 4.4 | 4.3 | 4.1 | 3.8 | 3.4 | 2.0 |
| (Control) | | | | | | | | |
| G. candidum in 1.0% SDS (Control) | 3.6 | 3.8 | 3.3 | 3.5 | 3.7 | 3.5 | 3.4 | 3.3 |
| G. candidum in 0.5% levulinic acid + | 3.0 | 2.6 | 2.6 | 2.4 | <0.7 | <0.7 | <0.7 | <0.7 |
| 0.05% SDS | | | | | | | | |
| G. candidum in 2.0% levulinic acid + 1.0% | 3.3 | <0.7 | — | — | — | — | — | — |
| SDS | | | | | | | | |

^{a}Initial inoculation level: Saccharomyces cerevisiae: 7.5 × 10⁷ CFU/ml; Debaryomyces hansenii: 7.4 × 10⁷ CFU/ml; Candida magnoliae: 3.4 × 10⁸ CFU/ml; Zygosaccharomyces bailii: 3.4 × 10⁷ CFU/ml; Geotrichum candidum: 1.2 × 10⁷ CFU/ml.
^{b}The actual time 0 was delayed by 5 to 10 seconds due to time for sample processing.
^{c}Negative by direct plating and enrichment culture.

### Example 23

TABLE 33
Effect of levulinic acids plus Sodium Dodecyl Sulfate (SDS) at different
concentrations at 21° C. on various mold species

| | Mold counts (log CFU/ml) at min: | | | | | | | |
|---|---|---|---|---|---|---|---|---|
| Mold Name^{a} | 0^{b} | 1 | 2 | 5 | 10 | 20 | 30 | 60 |
| Mucor hiemalis in 0.1M PBS (Control) | 6.1 | 6.1 | 6.1 | 6.2 | 6.4 | 6.1 | 6.1 | 6.2 |
| M. hiemalis in 3.0% levulinic acids | 6.1 | 6.2 | 6.2 | 6.0 | 5.8 | 5.1 | 4.8 | 4.1 |
| (Control) | | | | | | | | |
| M. hiemalis in 2.0% SDS (Control) | 6.0 | 5.8 | 5.8 | 6.0 | 5.9 | 5.8 | 5.8 | 5.4 |
| M. hiemalis in 0.5% levulinic + 0.05% SDS | 5.8 | 5.9 | 6.0 | 6.1 | 5.5 | 5.8 | 5.9 | 5.4 |
| M. hiemalis in 2% levulinic acid + 1.0% | 5.1 | 5.0 | 4.9 | 4.9 | 4.5 | 3.7 | 3.4 | 2.5 |
| SDS | | | | | | | | |
| M. hiemalis in 3% levulinic acid + 2% SDS | 5.6 | 5.6 | 5.5 | 5.0 | 4.7 | 4.6 | 3.2 | 2.4 |
| Penicillium pubeseus in 0.1M PBS | 4.9 | 4.8 | 4.8 | 4.8 | 4.9 | 4.8 | 4.9 | 4.7 |
| (Control) | | | | | | | | |
| P. pubeseus in 3.0% levulinic acid | 5.2 | 4.9 | 4.8 | 5.2 | 4.0 | 3.2 | 2.7 | 1.7 |
| P. pubeseus in 2.0% SDS | 4.4 | 4.3 | 4.4 | 4.4 | 4.5 | 4.5 | 4.4 | 4.4 |
| P. pubeseus in 0.5% levulinic acid + | 5.1 | 5.1 | 5.1 | 5.0 | 5.0 | 4.9 | 4.9 | 4.5 |
| 0.05% SDS | | | | | | | | |
| P. pubeseus 2% levulinic acid + 1% SDS | 5.2 | 5.2 | 5.1 | 5.0 | 4.8 | 4.6 | 4.4 | 4.2 |
| P. pubeseus in 3% levulinic acid + 2% | 3.5 | 3.2 | <0.7 | <0.7 | <0.7 | <0.7 | <0.7 | <0.7 |
| SDS | | | | | | | | |
| Penicillium. expansum in 0.1M PBS | 4.4 | 4.4 | 4.5 | 4.8 | 4.6 | 4.0 | 4.5 | 4.5 |
| (Control) | | | | | | | | |
| P. expansum in 3.0% levulinic acids | 4.3 | 4.4 | 4.2 | 4.0 | 3.7 | 3.3 | 3.3 | 2.4 |
| P. expansum in 2.0% SDS | 4.2 | 4.1 | 3.8 | 3.4 | 3.5 | 3.5 | 3.5 | 3.6 |
| P. expansum in 0.5% levulinic acid + | 4.5 | 3.9 | 3.6 | 3.2 | 2.8 | 2.7 | 2.0 | 2.0 |
| 0.05% SDS | | | | | | | | |
| P. expansum in 2.0% levulinic acids + | 4.1 | 3.7 | 3.6 | 3.4 | 3.3 | 3.0 | 2.5 | 1.7 |
| 1.0% SDS | | | | | | | | |
| Paecylomyces expansum in 3% levulinic | 3.9 | <0.7 | <0.7 | <0.7 | <0.7 | <0.7 | <0.7 | <0.7 |
| acid + 2% SDS | | | | | | | | |
| P. variotri in 0.1M PBS (Control) | 5.5 | 5.5 | 5.7 | 5.4 | 5.5 | 5.5 | 5.5 | 5.5 |
| P. variotri in 3.0% levulinic acid | 5.6 | 5.6 | 5.4 | 5.6 | 5.6 | 5.3 | 5.4 | 4.6 |
| P. variotri in 2.0% SDS | 5.6 | 5.5 | 5.5 | 5.4 | 5.4 | 5.6 | 5.6 | 5.6 |
| P. variotri in 0.5% levulinic acid + 0.05% | 5.2 | 5.2 | 4.8 | 4.5 | 4.1 | 4.4 | 3.8 | 3.4 |
| SDS | | | | | | | | |
| P. variotri in 2.0% levulinic acid + 1.0% | 4.3 | 3.8 | 3.4 | 3.0 | 2.7 | 2.3 | 1.5 | 0.7 |
| SDS | | | | | | | | |
| P. variotri in 3.0% levulinic acid + 2.0% | 4.6 | 4.4 | 4.4 | 3.6 | 2.9 | 2.2 | <0.7 | <0.7 |
| SDS | | | | | | | | |

^{a}Initial inoculation level: Mucor hiemalis: 3.1 × 10⁷ CFU/ml; Penicillium pubeseus: 6.9 × 10⁷ CFU/ml; Penicillium expansum: 2.9 × 10⁷ CFU/ml; Paecylomyces variotri: 2.7 × 10⁷ CFU/ml.
^{b}The actual time 0 was delayed by 5 to 10 seconds due to time for sample processing.

### Example 24

TABLE 34
Addition of levulinic acid plus SDS in tea for inhibition of Yeast (Candida magnolia)
at 21° C.

| | Amount | | | | | | | | |
|---|---|---|---|---|---|---|---|---|---|
| | of yeast | | | | | | | | |
| Group of liquid | added | Aerobic bacteria count | | | | Yeast count (CFU/ml) at | | | |
| tea | (CFU/ml) | (CFU/ml) at day | | | | day | | | |
| (500 ml/bottle) | & pH | 0 | 7 | 14 | 21 | 0 | 7 | 14 | 21 |
| Negative control | 0, 3.09 | <1.7 | <1.7 | <1.7 | <1.7 | <1.7 | <1.7 | <1.7 | <1.7 |
| Positive control | 10⁴, 3.11 | 4.7 | <1.7 | <1.7 | <1.7 | 4.6 | <1.7 | <1.7 | <1.7 |
| 0.5% levulinic | 10⁴, 3.0 | 4.5 | <1.7 | <1.7 | <1.7 | 4.5 | <1.7 | <1.7 | <1.7 |
| acid | | | | | | | | | |
| 0.05% levulinic | 10⁴, 3.1 | 4.7 | <1.7 | <1.7 | <1.7 | 4.7 | <1.7 | <1.7 | <1.7 |
| acid | | | | | | | | | |
| 0.5% levulinic | 10⁴, 3.09 | 4.8 | <1.7 | <1.7 | <1.7 | 4.4 | <1.7 | <1.7 | <1.7 |
| acid + 0.05% SDS | | | | | | | | | |
| 0.25% levulinic | 10⁴, 3.09 | 4.7 | <1.7 | <1.7 | <1.7 | 4.7 | <1.7 | <1.7 | <1.7 |
| acid + | | | | | | | | | |
| 0.025% SDS | | | | | | | | | |
| 0.125% levulinic | 10⁴, 3.1 | 4.8 | <1.7 | <1.7 | <1.7 | 4.7 | <1.7 | <1.7 | <1.7 |
| acid + | | | | | | | | | |
| 0.0125% SDS | | | | | | | | | |
| 0.0625% levulinic | 10⁴, 3.11 | 4.6 | <1.7 | <1.7 | <1.7 | 4.6 | <1.7 | <1.7 | <1.7 |
| acid + | | | | | | | | | |
| 0.00625% SDS | | | | | | | | | |
| 1.0% levulinic | 10⁴, 3.11 | 4.5 | <1.7 | <1.7 | <1.7 | 4.5 | <1.7 | <1.7 | <1.7 |
| acid + 0.1% SDS | | | | | | | | | |
| 0.05% SDS | 10⁴, 3.11 | 4.5 | <1.7 | <1.7 | <1.7 | 4.5 | <1.7 | <1.7 | <1.7 |
| 0.025% SDS | 10⁴, 3.11 | 4.5 | <1.7 | <1.7 | <1.7 | 4.5 | <1.7 | <1.7 | <1.7 |

LIPTON.TM green tea bottle (500 ml, purchased from a local retail store) and containing: Water, High Fructose Corn Syrup, Natural Flavor, Citric Acid, Sodium Hexametaphosphate (to protect flavor), Green Tea, Ascorbic Acid (to protect flavor), Phosphoric Acid, Potassium Sorbate (preserves freshness), Potassium Cinnamate (preserves freshness), Honey, Calcium Disodium, EDTA (to protect flavor), Caramel Color, Yellow 5, Blue 1

What is claimed:

1. A method of reducing a microbial population of a liquid, the method comprising contacting the liquid with between about 0.5% to about 5% by weight per volume of levulinic acid and between about 0.05% to about 2% by weight per volume of sodium dodecyl sulfate (SDS), wherein the levulinic acid and the SDS are effective in reducing the microbial load of the liquid.

2. The method of claim 1, wherein the liquid is suitable for consumption by an animal or human.

3. The method of claim 1, wherein the liquid has a pH value between about 0 and about 7.

4. The method of claim 1, wherein the liquid is water or a beverage.

5. The method of claim 4, wherein the beverage is a carbonated beverage.

6. The method of claim 4, wherein the beverage is a fruit juice.

7. The method of claim 4, wherein the beverage is an infusion.

8. The method of claim 4, wherein the beverage is selected from coffee or tea.

9. The method of claim 1, wherein the microbicidal levulinic acid and the SDS remain in the liquid after packaging of said liquid.

10. A method for decontaminating a solid surface of a beverage manufacturing facility, said method comprising the steps of contacting the solid surface with an aqueous composition comprising between about 0.5% to about 5% by weight per volume of levulinic acid and between about 0.05% to about 2% by weight per volume of sodium dodecyl sulfate (SDS).

11. The method of claim 10, wherein the solid surface is of a beverage container.

12. The method of claim 11, wherein the beverage container is selected from the group consisting of: a bottle, a can, a carton, and a bag.
